(19) United States
(12) Patent Application Publication
(10) Pub. No.: US 2026/0292371 A1
(43) Pub. Date: Sep. 24, 2026

(54) WEIGHTED ADDITION CIRCUIT AND SOLID-STATE IMAGE PICKUP APPARATUS

(71) Applicant: SONY SEMICONDUCTOR SOLUTIONS CORPORATION, KANAGAWA (JP)

(72) Inventor: KATSUHIKO HANZAWA, KANAGAWA (JP)

(21) Appl. No.: 19/471,796

(22) PCT Filed: Mar. 13, 2024
(86) PCT No.: PCT/JP2024/009704

§ 371 Date: Oct. 2, 2025

(30) Foreign Application Priority Data
Apr. 26, 2023 (JP) 2023-072751

(51) Int. Cl. H04N 25/78

(52) U.S. Cl. CPC H04N 25/78

(57) ABSTRACT

[Object] To provide a weighted addition circuit and a solid-state image pickup apparatus that are capable of increasing the number of weighted additions while suppressing an increase in the number of wirings of readout lines.

[Solving Means] A weighted addition circuit according to the present disclosure includes: a readout wiring which accepts an input of a plurality of signals read out by a vertical signal line of a solid-state image pickup apparatus; a first switch which connects or disconnects the vertical signal line and the readout wiring; a plurality of capacitors which sample-hold the plurality of signals; and a plurality of second switches which connect or disconnect the readout wiring and the capacitors.

### TECHNICAL FIELD

The present disclosure relates to a weighted addition circuit and a solid-state image pickup apparatus.

### BACKGROUND ART

A deep neural network (Deep Neural Network (also called DNN)) is used as a technology for improving recognition performance, but weighted addition used in this technology requires a large number of calculations and consumes a large amount of power.

Meanwhile, there is proposed, as compared to a conventional method in which the weighted addition is performed in a digital circuit, a technology that reduces power consumption by completing the calculations before performing AD (Analog to Digital) conversion. For example, there is proposed a technology in which, in an image sensor, the weighted addition is performed on signals output from a pixel array so as to perform a convolution calculation.

### CITATION LIST

### Patent Literature

Patent Literature 1: Japanese Patent Application Laid-open No. 2020-113809

### DISCLOSURE OF INVENTION

### Technical Problem

In the technology described above, signals are read out from the pixel array through a plurality of readout lines. In addition, the weighted addition can be performed by performing addition through capacitors respectively corresponding to the readout lines. However, the number of signals to be added at the same time and the number of wirings of the readout lines are 1:1, so if the number of signals to be added is increased, the number of signals also increases accordingly.

In view of these problems, the present disclosure provides a weighted addition circuit and a solid-state image pickup apparatus that are capable of increasing the number of weighted additions while suppressing an increase in the number of wirings of the readout lines.

### Solution to Problem

A weighted addition circuit according to a first aspect of the present disclosure includes: a readout wiring which accepts an input of a plurality of signals read out by a vertical signal line of a solid-state image pickup apparatus; a first switch which connects or disconnects the vertical signal line and the readout wiring; a plurality of capacitors which sample-hold the plurality of signals; and a plurality of second switches which connect or disconnect the readout wiring and the capacitors. Accordingly, by sharing the readout wiring by the capacitors, the weighted addition circuit can suppress an increase of the number of wirings. Even if the number of signals to be added increases, since the weighted addition circuit sequentially sample-holds the signals and performs the weighted addition, the trade-off between the number of weighted additions and the number of wirings can be eliminated.

Also in this first aspect, the solid-state image pickup apparatus includes a cell array including a mechanism for retaining the plurality of signals, the vertical signal line which reads out the plurality of signals from the cell array, and an AD conversion section which performs AD conversion of a signal obtained by performing weighted addition in the weighted addition circuit, and the weighted addition circuit is connected to the cell array, the vertical signal line, and the AD conversion section. Accordingly, by sharing the readout wiring by the capacitors, the weighted addition circuit can suppress an increase of the number of wirings. Even if the number of signals to be added increases, since the weighted addition circuit sequentially sample-holds the signals and performs the weighted addition, the trade-off between the number of weighted additions and the number of wirings can be eliminated.

Also in this first aspect, the weighted addition circuit sequentially sample-holds the plurality of signals sequentially read out by the vertical signal line, and performs weighted addition after completing the sample and hold of the plurality of signals. Accordingly, by sharing the readout wiring by the capacitors, the weighted addition circuit can suppress an increase of the number of wirings. Even if the number of signals to be added increases, since the weighted addition circuit sequentially sample-holds the signals and performs the weighted addition, the trade-off between the number of weighted additions and the number of wirings can be eliminated.

Also in this first aspect, a plurality of cells included in the cell array are pixels including photodiodes or memories included in a memory array. Accordingly, the weighted addition circuit can be connected to not only a pixel array section but also the cell array such as the memory array to perform the weighted addition.

Also in this first aspect, the weighted addition circuit further includes a fourth switch which enables a terminal of each of the plurality of capacitors, that is on an opposite side of a terminal on a side of the readout wiring, to switch a value of a terminal voltage. Accordingly, the weighted addition circuit can realize a function of a successive comparison type AD converter without separately adding a capacitor.

Also in this first aspect, the AD conversion section performs a successive comparison operation of a DAC signal generated by the weighted addition circuit on the basis of the switch by the fourth switch and the signal obtained by the weighted addition. Accordingly, the weighted addition circuit can realize the function of a successive comparison type AD converter without separately adding a capacitor.

A solid-state image pickup apparatus according to a second aspect of the present disclosure includes: a cell array including a mechanism for retaining a plurality of signals; a vertical signal line which reads out the plurality of signals from the cell array; a weighted addition circuit which sample-holds the plurality of signals read out by the vertical signal line and performs weighted addition; and an AD conversion section which performs AD conversion of a signal obtained by performing the weighted addition in the weighted addition circuit, and the weighted addition circuit includes a readout wiring which accepts an input of the plurality of signals read out by the vertical signal line, a first switch which connects or disconnects the vertical signal line and the readout wiring, a plurality of capacitors which sample-hold the plurality of signals, and a plurality of second switches which connect or disconnect the readout wiring and the capacitors. Accordingly, by sharing the readout wiring by the capacitors, the weighted addition circuit can suppress an increase of the number of wirings. Even if the number of signals to be added increases, since the weighted addition circuit sequentially sample-holds the signals and performs the weighted addition, the trade-off between the number of weighted additions and the number of wirings can be eliminated.

Also in this second aspect, the weighted addition circuit sequentially sample-holds the plurality of signals sequentially read out by the vertical signal line, and performs the weighted addition after completing the sample and hold of the plurality of signals. Accordingly, by sharing the readout wiring by the capacitors, the weighted addition circuit can suppress an increase of the number of wirings. Even if the number of signals to be added increases, since the weighted addition circuit sequentially sample-holds the signals and performs the weighted addition, the trade-off between the number of weighted additions and the number of wirings can be eliminated.

Also in this second aspect, a plurality of cells included in the cell array are pixels including photodiodes or memories included in a memory array. Accordingly, the weighted addition circuit can be connected to not only the pixel array section but also the cell array such as the memory array to perform the weighted addition.

Also in this second aspect, the plurality of capacitors include a first capacitor and a second capacitor having different capacitances. Accordingly, the weighted addition circuit can change the weighting of input signals according to a magnitude of the capacitances.

Also in this second aspect, a buffer circuit which provides a delay time in the input of the plurality of signals is connected between the vertical signal line and the weighted addition circuit. Accordingly, the weighted addition circuit can provide a delay time when inputting signals to the weighted addition circuit by using the buffer circuit, and suppress a deviation of a charge accumulation time due to a difference in the capacitance of the capacitors.

Also in this second aspect, the weighted addition circuit further includes one or a plurality of dummy capacitors which adjust a difference between the capacitances during the sample and hold by the first capacitor and the second capacitor, and one or a plurality of third switches which connect or disconnect the readout wiring and the dummy capacitors.

Accordingly, the weighted addition circuit can artificially adjust all capacitors to become constant when performing the sample and hold, and suppress a deviation of a charge accumulation time due to a difference in the capacitance of the capacitors.

Also in this second aspect, the weighted addition circuit accumulates a charge in the one or plurality of dummy capacitors on the basis of the difference between the capacitance of the first capacitor and the capacitance of the second capacitor. Accordingly, the weighted addition circuit can artificially adjust all capacitors to become constant when performing the sample and hold, and suppress a deviation of a charge accumulation time due to a difference in the capacitance of the capacitors.

A solid-state image pickup apparatus according to a third aspect of the present disclosure includes: a cell array including a mechanism for retaining a plurality of signals; a vertical signal line which reads out the plurality of signals from the cell array; a first weighted addition circuit which sample-holds the plurality of signals read out by the vertical signal line and performs weighted addition of positive values; a second weighted addition circuit which sample-holds the plurality of signals read out by the vertical signal line and performs weighted addition of negative values; and an AD conversion section which performs AD conversion of a signal obtained by the weighted addition in the first weighted addition circuit and a signal obtained by the weighted addition in the second weighted addition circuit, and each of the first weighted addition circuit and the second weighted addition circuit includes a readout wiring which accepts an input of the plurality of signals read out by the vertical signal line, a first switch which connects or disconnects the vertical signal line and the readout wiring, a plurality of capacitors which sample-hold the plurality of signals, and a plurality of second switches which connect or disconnect the readout wiring and the capacitors. Accordingly, the weighted addition circuit can perform the weighted addition of the negative values in addition to the weighted addition of the positive values.

Also in this third aspect, a plurality of cells included in the cell array are pixels including photodiodes or memories included in a memory array. Accordingly, the weighted addition circuit can be connected to not only the pixel array section but also the cell array such as the memory array to perform the weighted addition.

Also in this third aspect, each of the first weighted addition circuit and the second weighted addition circuit sequentially sample-holds the plurality of signals sequentially read out by the vertical signal line, and performs the weighted addition of the positive values and the weighted addition of the negative values after completing the sample and hold of the plurality of signals. Accordingly, the weighted addition circuit can perform the weighted addition of the negative values in addition to the weighted addition of the positive values.

Also in this third aspect, a plurality of cells included in the cell array include a first selection transistor which makes a switch so that the plurality of signals are input to the first weighted addition circuit, and a second selection transistor which makes a switch so that the plurality of signals are input to the second weighted addition circuit. Accordingly, the cells can input signals to the first weighted addition circuit or the second weighted addition circuit by switching these transistors. Accordingly, the weighted addition circuit can perform the weighted addition of the negative values in addition to the weighted addition of the positive values. Furthermore, regarding the weighted addition circuit, based on the opening and closing of the first selection transistor and the second selection transistor, the first weighted addition circuit can input signals of positive values, and at the same time, the second weighted addition circuit can input signals of negative values.

Also in this second aspect, the weighted addition circuit further includes a fourth switch which enables a terminal of each of the plurality of capacitors, that is on an opposite side of a terminal on a side of the readout wiring, to switch a value of a terminal voltage. Accordingly, the weighted addition circuit can realize the function of a successive comparison type AD converter without separately adding a capacitor.

Also in this second aspect, the AD conversion section performs a successive comparison of a DAC signal generated by the weighted addition circuit on the basis of the switch by the fourth switch and the signal obtained by the weighted addition. Accordingly, the weighted addition circuit can realize the function of a successive comparison type AD converter without separately adding a capacitor.

Also in this third aspect, each of the first weighted addition circuit and the second weighted addition circuit further includes a fourth switch which enables a terminal of each of the plurality of capacitors, that is on an opposite side of a terminal on a side of the readout wiring, to switch a value of a terminal voltage. Accordingly, the weighted addition circuit can realize the function of a successive comparison type AD converter without separately adding a capacitor.

### BRIEF DESCRIPTION OF DRAWINGS

FIG. 1 A block diagram showing a schematic configuration of a solid-state image pickup apparatus according to a first embodiment.

FIG. 2 A diagram showing an example of a circuit configuration of a pixel arrayed in a pixel array section in the first embodiment.

FIG. 3 A diagram showing an example of a circuit configuration of a weighted addition circuit according to the first embodiment.

FIG. 4 An example of a timing chart of the weighted addition circuit according to the first embodiment.

FIG. 5 Another example of the timing chart of the weighted addition circuit and the like in the first embodiment.

FIG. 6 Diagrams each showing a modified example of a pixel in the first embodiment.

FIG. 7 A modified example of the pixel array in the first embodiment.

FIG. 8 A circuit diagram of a weighted addition circuit according to a second embodiment.

FIG. 9 A circuit diagram of a weighted addition circuit according to a third embodiment.

FIG. 10 A timing chart of the weighted addition circuit according to the third embodiment.

FIG. 11 A circuit diagram of a weighted addition circuit and the like according to a fourth embodiment.

FIG. 12 A timing chart of the weighted addition circuit and the like in the fourth embodiment.

FIG. 13 A circuit diagram of a weighted addition circuit and the like according to a fifth embodiment.

FIG. 14 Circuit diagrams of a weighted addition circuit and the like according to a sixth embodiment.

FIG. 15 A circuit diagram of a modified example of the weighted addition circuit and the like in the sixth embodiment.

FIG. 16 A block diagram showing a configuration example of a vehicle control system.

FIG. 17 A diagram showing an example of sensing areas.

### MODES FOR CARRYING OUT THE INVENTION

Hereinafter embodiments according to the present disclosure will be described with reference to the drawings.

### First Embodiment

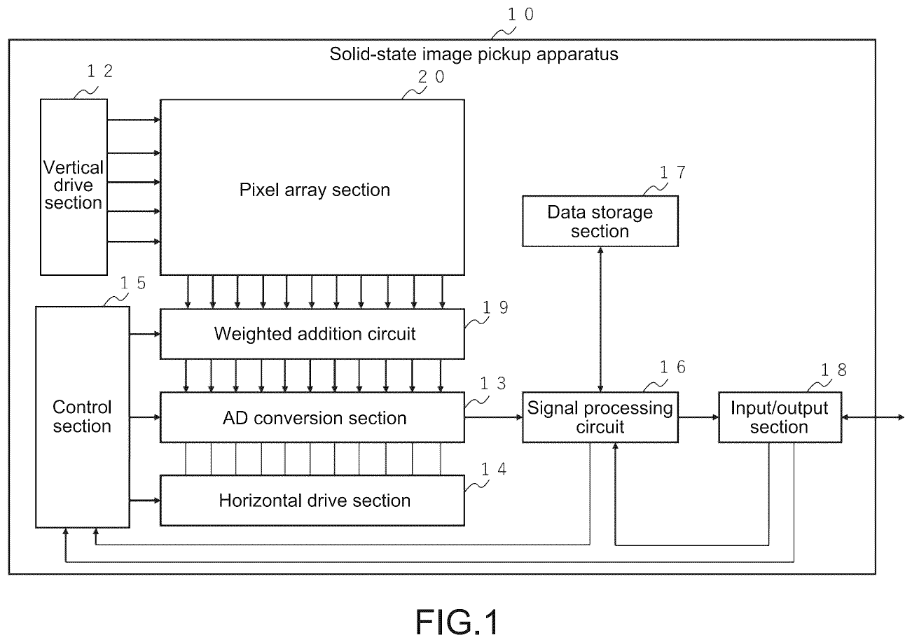

FIG. 1 is a block diagram showing a schematic configuration of a solid-state image pickup apparatus according to the first embodiment.

A solid-state image pickup apparatus 10 shown in FIG. 1 is configured to include a pixel array section 20 in which a plurality of pixels are arranged in a matrix and a peripheral circuit section in a periphery of the pixel array section 20. The peripheral circuit section includes a vertical drive section 12, an AD conversion section 13, a horizontal drive section 14, a control section 15, a signal processing circuit 16, a data storage section 17, an input/output section 18, and the like.

Each pixel arranged two-dimensionally in the pixel array section 20 is constituted of a photodiode as a photoelectric conversion section, a plurality of pixel transistors, and the like. The plurality of pixel transistors are, for example, MOS transistors such as a transfer transistor, an amplification transistor, a selection transistor, and a reset transistor. In the pixels of the pixel array section 20, for example, red, green, or blue color filters are arranged in a Bayer array, and each pixel outputs a pixel signal (hereinafter, will also be simply referred to as a signal) of either red, green, or blue.

The vertical drive section 12 is constituted of, for example, a shift register, and supplies drive pulses to the pixels of the pixel array section 20 via pixel drive wiring (not shown) to drive the pixels in units of rows. That is, the vertical drive section 12 selectively scans the pixels of the pixel array section 20 sequentially in the vertical direction in the units of rows, and supplies pixel signals that are each based on a signal charge generated in accordance with an amount of incident light in the photodiode of the pixel, to a weighted addition circuit 19 through a vertical signal line provided in common in units of columns.

The weighted addition circuit 19 is provided for each group of pixels that share the vertical signal line, for example. The vertical signal line reads out a plurality of pixel signals corresponding to a predetermined unit of weighted addition from the pixels of the pixel array section 20, and sequentially supplies the signals to the weighted addition circuit 19. The weighted addition circuit 19 performs weighted addition on the signals that have been accepted as an input from the vertical signal line. This unit of weighted addition is selected from the pixels that share the vertical signal line. Details of the weighted addition circuit 19 will be described later.

An AD conversion section (ADC) 13 performs CDS (Correlated Double Sampling) processing for removing pixel-specific fixed pattern noise and/or AD conversion on the signals output from the weighted addition circuit 19.

The horizontal drive section 14 is constituted of, for example, a shift register, and sequentially outputs horizontal scanning pulses to sequentially output (digital) pixel signals obtained by performing AD conversion on the pixels of a predetermined row, that are retained in the AD conversion section 13, to the signal processing circuit 16.

The control section 15 receives clock signals input from outside and data instructing an operation mode and/or the like, to control operations of the entire solid-state image pickup apparatus 10. For example, the control section 15 generates a vertical synchronization signal, a horizontal synchronization signal, and the like based on the input clock signals, and supplies the signals to the vertical drive section 12, the AD conversion section 13, the horizontal drive section 14, and the like.

The signal processing circuit 16 executes various types of digital signal processing such as black level adjustment processing, column variation correction processing, and demosaic processing on the pixel signals supplied from the AD conversion section 13 as necessary, and supplies the results to the input/output section 18. Depending on the operation mode, the signal processing circuit 16 may output the pixel signals after performing only buffering. The data storage section 17 stores data of parameters required for signal processing performed by the signal processing circuit 16, and the like. Further, for example, the data storage section 17 also includes a frame memory for storing image signals in the processing such as the demosaic processing. The signal processing circuit 16 is capable of storing parameters and the like input from an external image processing apparatus in the data storage section 17 via the input/output section 18, and selecting and executing the signal processing as appropriate based on instructions from the external image processing apparatus.

The input/output section 18 outputs the image signals sequentially input from the signal processing circuit 16 to the external image processing apparatus, for example, a subsequent ISP (Image Signal Processor) and the like. The input/output section 18 also supplies signals and parameters input from the external image processing apparatus to the signal processing circuit 16 and the control section 15.

The solid-state image pickup apparatus 10 is configured as described above, and is, for example, a CMOS image sensor of a so-called column AD type in which CDS processing and AD conversion processing are performed for each pixel column.

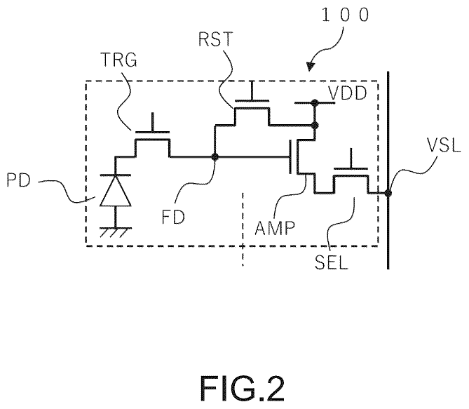

FIG. 2 is a diagram showing an example of a circuit configuration of a pixel arrayed in the pixel array section in the first embodiment.

A pixel 100 shown in FIG. 2 includes a photodiode PD, a transfer transistor TRG, a floating diffusion FD, a reset transistor RST, an amplification transistor AMP, and a selection transistor SEL. The photodiode PD receives and

photoelectrically converts incident light and accumulates an obtained charge. When a drive signal supplied to a gate of the transfer transistor TRG becomes Hi and the transfer transistor TRG is turned on, the charge accumulated in the photodiode PD is transferred to the floating diffusion FD via the transfer transistor TR.

The floating diffusion FD temporarily retains the charge transferred from the transfer transistor TR. Further, a vertical signal line VSL is connected to the floating diffusion FD via the amplification transistor AMP and the selection transistor SEL. The vertical signal line VSL is connected to the weighted addition circuit 19 in the same column.

When the reset transistor RST is turned on by a reset signal, the charge retained in the floating diffusion FD is discharged to a constant voltage source VDD, thereby resetting a potential of the floating diffusion FD.

The amplification transistor AMP outputs a pixel signal corresponding to the potential of the floating diffusion FD. That is, the amplification transistor AMP constitutes a source follower circuit together with a load MOS (not shown) as a constant current source, and a pixel signal indicating a level corresponding to the charge retained in the floating diffusion FD is output from the amplification transistor AMP to the weighted addition circuit 19 via the selection transistor SEL.

The selection transistor SEL is turned on when the pixel 100 is selected by a selection signal, and outputs a pixel signal of the pixel 100 to the weighted addition circuit 19 via the vertical signal line VSL.

It is noted that although the pixel circuit shown in FIG. 2 is a rolling shutter type pixel circuit, a charge retention section (memory section) that accumulates the charge transferred by the transfer transistor TRG and a transfer transistor that transfers the charge in the charge retention section to the floating diffusion FD may be further provided between the transfer transistor TRG and the floating diffusion FD so as to enable global shutter type driving to be performed.

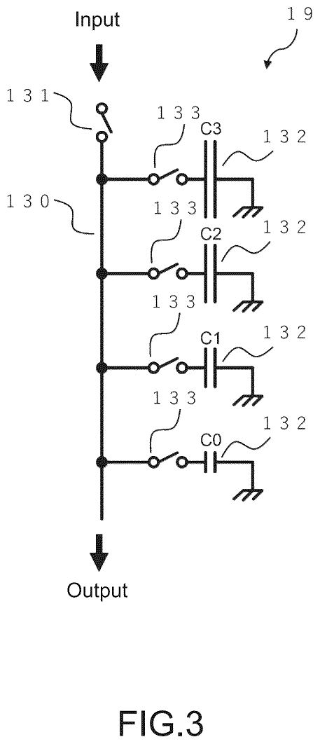

FIG. 3 is a diagram showing an example of a circuit configuration of the weighted addition circuit in the first embodiment.

The weighted addition circuit 19 shown in FIG. 3 includes a readout wiring 130, a first switch 131, a plurality of capacitors 132, and a plurality of second switches 133. Furthermore, via the readout wiring 130, an input side of the weighted addition circuit 19 is connected to the plurality of pixels 100 via the vertical signal line VSL, and an output side thereof is connected to the AD conversion section 13. In other words, the weighted addition circuit 19 sequentially accepts inputs of signals from the plurality of pixels 100 via the vertical signal line VSL, performs weighted addition, and then inputs these signals to the AD converter.

In FIG. 3, the plurality of capacitors 132 have different capacitances. In this manner, the weighted addition circuit 19 may include, as the capacitors 132, a first capacitor and a second capacitor having different capacitances. The weighted addition circuit 19 can change the weighting of input signals according to a magnitude of the capacitance. In the example shown in FIG. 3, the weighted addition circuit 19 includes four capacitors 132 and four second switches 133, and the magnitudes of the capacitances of the capacitors 132 are C3, C2, C1, and C0 (C3>C2>C1>C0). In addition, the weighted addition circuit 19 performs weighted addition for the pixels 100 connected to the same vertical signal line VSL in a unit of the number of capacitors 132. For example, when 12 pixels 100 are connected to the same vertical signal line VSL and the weighted addition circuit 19 includes four capacitors 132, these 12 pixels 100 are subjected to weighted addition in three separate times.

The first switch 131 connects or disconnects the vertical signal line VSL and the readout wiring 130. When the first switch 131 is in an on state, the vertical signal line VSL and the readout wiring 130 are connected to each other so as to accept an input of signals output from the pixels 100.

The second switches 133 connect or disconnect the readout wiring 130 and the capacitors 132. When the second switch 133 is in the on state, the signal accepted as an input by the weighted addition circuit 19 connects the readout wiring 130 to the corresponding capacitor 132 so as to accumulate a charge in the capacitor 132. Such a manner in which the weighted addition circuit 19 accepts an input of a signal from the vertical signal line VSL and accumulates a signal charge in the corresponding capacitor 132 is called sample and hold. The weighted addition circuit 19 can perform weighting of each signal based on the magnitude of the capacitance of the capacitor 132.

After the sample and hold is completed in each of the capacitors 132, the weighted addition circuit 19 turns on each of the second switches 133 and adds all the signals that have undergone the sample and hold in the readout wiring 130. Adding all the signals that have undergone the sample and hold in this manner is called weighted addition.

The weighted addition signal that has been subjected to the weighted addition is output to the AD conversion section 13. The AD conversion section 13 accepts an input of the weighted addition signal and performs AD conversion processing. Alternatively, the AD conversion section 13 may perform CDS processing first, and then perform the AD conversion processing of the weighted addition signal.

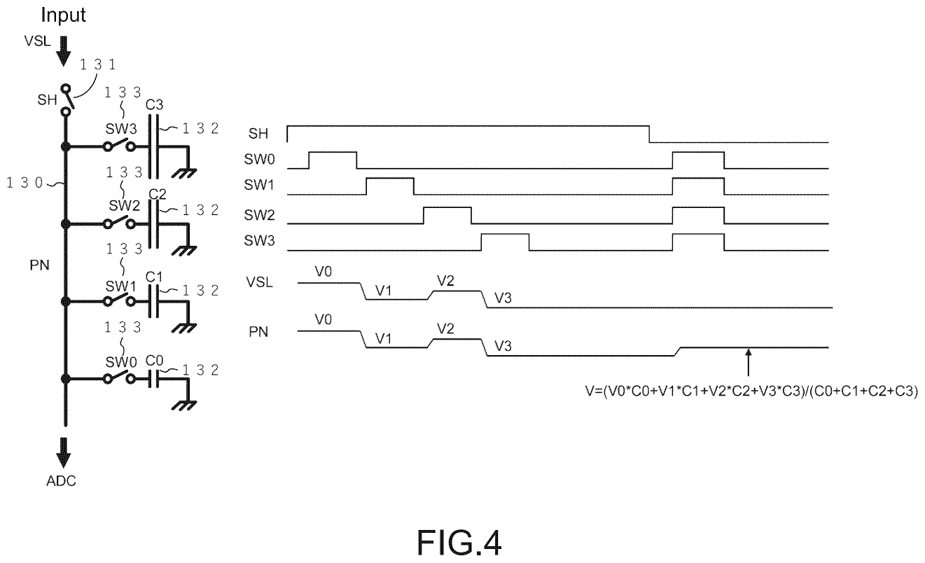

FIG. 4 is an example of a timing chart of the weighted addition circuit in the first embodiment.

FIG. 4 shows an example in which the weighted addition circuit 19 sequentially accepts inputs of signals from four pixels and performs weighted addition.

The timing chart shown in FIG. 4 shows an example in which the capacitors 132 whose magnitudes of capacitances are C0, C1, C2, and C3 (C0<C1<C2<C3) sequentially sample-hold a plurality of signals (signal voltages V0 to V3) read out from the pixel array section 20 via the vertical signal line VSL. The timing chart shown in FIG. 4 also shows an example in which the weighted addition is performed by the readout wiring 130 after completion of the sample and hold by the capacitors 132.

In this example, the second switches 133 respectively connected to the capacitors 132 whose magnitudes of capacitances are C0, C1, C2, and C3 are represented by SW0, SW1, SW2, and SW3, respectively.

Although the example in which the weighted addition circuit 19 according to the present embodiment turns on the second switches 133 in the order of SW0 to SW3 to perform sample and hold is shown, the second switches 133 may be turned on in the order of SW3 to SW0, or in other orders, for example. Further, for ease of explanation, the first switch 131 is represented by SH in the timing chart shown in FIG. 4. Furthermore, the readout wiring 130 is represented by PN.

First, the weighted addition circuit 19 turns on the first switch 131 to connect the vertical signal line VSL and the readout wiring 130, and accepts inputs of signals from the pixel array section 20. At this time, the voltage of SH becomes Hi, and such a voltage state is maintained until the start of weighted addition.

Next, the weighted addition circuit 19 turns on SW0 out of the second switches 133, and connects the readout wiring 130 to C0 out of the capacitors 132. C0 accepts an input of a signal having a signal voltage V0 and sample-holds the signal. At this time, the voltage state of SW0 becomes Hi, and such a voltage state is maintained until a charge is accumulated in C0. Further, the charge Q0 accumulated in C0 is expressed by Equation (1).

$$Q 0 = V 0 \times C 0 \qquad ( 1 )$$

Next, the weighted addition circuit 19 turns on SW1 out of the second switches 133, and connects the readout wiring 130 to C1 out of the capacitors 132. C1 accepts an input of a signal having a signal voltage V1 and sample-holds the signal. At this time, the voltage state of SW1 becomes Hi, and such a voltage state is maintained until a charge is accumulated in C1. Further, the charge Q1 accumulated in C1 is expressed by Equation (2).

$$Q 1 = V 1 \times C 1 \qquad ( 2 )$$

Next, the weighted addition circuit 19 turns on SW2 out of the second switches 133, and connects the readout wiring 130 to C2 out of the capacitors 132. C2 accepts an input of a signal having a signal voltage V2 and sample-holds the signal. At this time, the voltage state of SW2 becomes Hi, and such a voltage state is maintained until a charge is accumulated in C2. Further, the charge Q2 accumulated in C2 is expressed by Equation (3).

$$Q 2 = V 2 \times C 2 \qquad ( 3 )$$

Next, the weighted addition circuit 19 turns on SW3 out of the second switches 133, and connects the readout wiring 130 to C3 out of the capacitors 132. C3 accepts an input of a signal having a signal voltage V3 and sample-holds the signal. At this time, the voltage state of SW3 becomes Hi, and such a voltage state is maintained until a charge is accumulated in C3. Further, the charge Q3 accumulated in C3 is expressed by Equation (4).

$$Q 3 = V 3 \times C 3 \qquad ( 4 )$$

After completing the sample and hold by the capacitors 132, the weighted addition circuit 19 turns on all of the second switches 133 and performs addition in the readout wiring 130. The signal voltage V of the readout wiring 130 at this time is expressed by Equation (5).

$$V = ( Q 0 + Q 1 + Q 2 + Q 3 ) / ( C 0 + C 1 + C 2 + C 3 ) \qquad ( 5 )$$

As described above, the signal obtained by the weighted addition is input to the AD conversion section 13. Further, a bit-serial calculation can be performed by adding the signals while setting a capacitance ratio of C3 to C0 to be a power of 2. In this manner, the values of the capacitors 132 can be designed flexibly.

Although this example has described the case where the weighted addition circuit 19 turns on the switches in the order of SW0, SW1, SW2, and SW3, this order is not limited, and the switches may be turned on in any order.

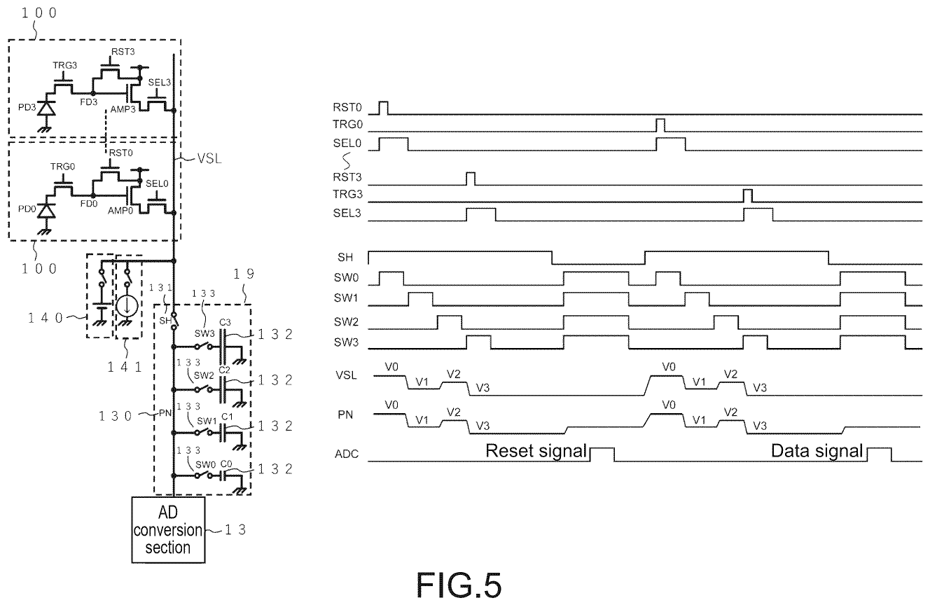

FIG. 5 is another example of the timing chart of the weighted addition circuit and the like in the first embodiment.

Similar to the example shown in FIG. 4, the circuit of FIG. 5 shows an example in which inputs of signals are sequentially accepted from four pixels 100 to perform weighted addition. Also in the circuit shown in FIG. 5, a dynamic source follower voltage source 140 and a source follower current source 141 are connected to the vertical signal line VSL. A power supply voltage value of the voltage source 140 may be any voltage value including 0 V. Alternatively, in the circuit shown in FIG. 5, only one of the voltage source 140 or the current source 141 may be connected to the vertical signal line VSL.

Also, this example shows the case where the AD conversion section 13 performs a CDS operation in performing the weighted addition. The CDS operation is an operation of reading out a signal from the pixel 100 twice and obtaining a difference between those signals. In this CDS operation, a signal obtained when the floating diffusion FD is initialized is read out as a P-phase level, and a signal obtained when a charge is transferred from the photodiode PD to the floating diffusion FD is read out as a D-phase level. Fixed pattern noise is removed by obtaining a difference between these P-phase level and D-phase level.

Specifically, using the timing chart shown in FIG. 5, first, as the readout of the P-phase level, the floating diffusion FD is initialized by the reset transistor RST0, the selection transistor SEL0 is turned on, and a reset level signal is transmitted to the weighted addition circuit 19. The weighted addition circuit 19 sample-holds the reset level signal by the corresponding capacitor C0. After repeating this operation from C0 to C3 and completing the sample and hold of the signals, the weighted addition circuit 19 performs addition in the readout wiring 130. Further, the signal obtained by the addition is input to the AD conversion section 13 as a reset signal and is subjected to AD conversion.

Next, as the readout of the D-phase level, the transfer transistor TRG3 is turned on, and the selection transistor SEL is also turned on, to thus transmit a charge accumulated in the photodiode PD to the weighted addition circuit 19. The weighted addition circuit 19 sample-holds the signal by the corresponding capacitor C0. After repeating this operation from C0 to C3 and completing the sample and hold of the signals, the weighted addition circuit 19 performs weighted addition in the readout wiring 130. The signal obtained by the weighted addition is input to the AD conversion section 13 as a data signal and is subjected to AD conversion.

The AD conversion section 13 obtains a difference between the data signal and the reset signal to remove fixed pattern noise.

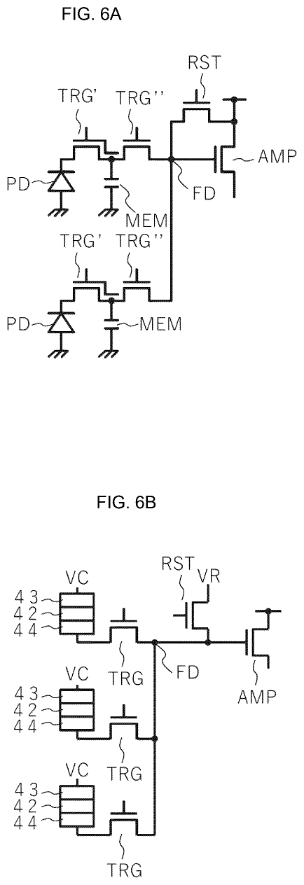

FIG. 6 are diagrams each showing a modified example of a pixel in the first embodiment.

FIG. 6A shows an example of a so-called pixel sharing circuit configuration in which a configuration including the photodiode PD, a first transfer transistor TRG′, a second transfer transistor TRG″, and a memory MEM is regarded as one unit. In FIG. 6A, these two units share the floating diffusion FD, the reset transistor RST, and the amplification transistor AMP.

The first transfer transistor TRG′ connected to the photodiode PD side transfers the charge accumulated in the photodiode PD to the memory MEM. Further, the second transfer transistor TRG″ connected to the floating diffusion FD side transfers the charge accumulated in the memory MEM to the floating diffusion FD.

The circuit configuration shown in FIG. 6A differs from that of the pixel 100 shown in FIG. 2 in the point of including the memory MEM and the first transfer transistor TRG′ that transfers a charge to the memory MEM in addition to the second transfer transistor TRG″ that transfers a charge to the floating diffusion FD. In addition, the circuit configuration shown in FIG. 6A differs in the point of including two photodiodes PD and the like.

In this circuit configuration, the sharing number of circuits such as the floating diffusion FD to be shared by the photodiode PD, the first transfer transistor TRG′, the second transfer transistor TRG″, and the memory MEM is not limited to two. An arbitrary number of photodiodes PD and the like can share the circuits such as the floating diffusion FD.

FIG. 6B shows an example of a pixel sharing circuit configuration in which a configuration including an organic photoelectric conversion film or an inorganic photoelectric conversion film (hereinafter, will simply be referred to as a photoelectric conversion film 42), a transparent electrode 43, a lower electrode 44, and the transfer transistor TRG is regarded as one unit. In FIG. 6B, these three units share the floating diffusion FD, the reset transistor RST, and the amplification transistor AMP. It is noted that in the circuit configuration shown in FIG. 5B, VC represents a power supply voltage connected to the transparent electrode 43, and VR represents a power supply voltage connected to the reset transistor transistor RST.

The circuit configuration shown in FIG. 6B differs from that of the pixel 100 shown in FIG. 2 in that the photodiode PD shown in FIG. 2 is changed to a three-layer configuration including the photoelectric conversion film 42, the transparent electrode 43, and the lower electrode 44 and the selection transistor SEL is removed.

In this circuit configuration, the sharing number of circuits such as the floating diffusion FD to be shared by the photoelectric conversion film 42, the transparent electrode 43, and the lower electrode 44 is not limited to three. An arbitrary number of photoelectric conversion films 42 and the like can share the circuits such as the floating diffusion FD.

Without being limited to the example described above, the pixel 100 may have another configuration including the photodiode PD or the photoelectric conversion film 42. Furthermore, the pixel 100 may include the memory MEM that temporarily accumulates a charge generated in the photodiode PD or the photoelectric conversion film 42.

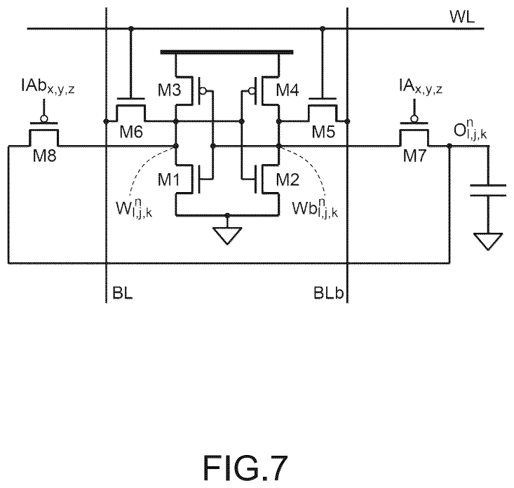

FIG. 7 shows a modified example of the pixel array in the first embodiment.

FIG. 7 shows an example of a Computation in Memory (CiM) having an SRAM (Static Random Access Memory) structure including six transistors M1 to M6. The SRAM structure includes, for example, two sets of inverters that are each constituted of two transistors that retain signals and are cross-connected, and two transistors that respectively read out and write from/to the inverters. In the example shown in FIG. 7, the SRAM structure includes an inverter constituted of a transistor M1 and a transistor M3 and an inverter constituted of a transistor M2 and a transistor M4, and the inverters are cross-connected. In addition, a transistor M5 and a transistor M6 that perform writing and reading are respectively connected to the inverters. Also in this example, in the Computation in Memory, a transistor M7 is connected to a source of the transistor M2 and a drain of the transistor M4. Also in this example, in the Computation in Memory, a transistor M8 is connected to a source of the transistor M1 and a drain of the transistor M3.

For example, in a deep neural network, when performing a product-sum operation of signals, a memory may be used as a mechanism for retaining the signals as described above. Further, the memory is constituted of elements for retaining signals, such as a transistor and a capacitor. In addition to the SRAM structure exemplified in FIG. 7, a circuit including an array structure of a memory such as a ReRAM (Resistive Random Access Memory) also called a resistive random access memory, a FeRAM (Ferroelectric Random Access Memory) also called a ferroelectric memory, or an MRAM (Magnetoresistive Random Access Memory) also called a magnetoresistive memory may be connected to the input side of the weighted addition circuit 19. A structure in which memories are arranged in an array is called a memory array. This memory array may be a one-dimensional structure instead of the two-dimensional structure. Further, a capacitor ladder circuit may be connected to the input side of the weighted addition circuit 19.

A mechanism for retaining signals, such as the pixel 100 including the photodiode PD described above or a memory included in a memory array, is called a cell. An array structure of cells, such as the pixel array section 20 or the memory array described above, is called a cell array.

Further, the cell array and the weighted addition circuit 19 may be mounted on different substrates. For example, the cell array may be mounted on a first substrate, and the weighted addition circuit 19 and the AD conversion section 13 may be mounted on a second substrate. In addition to these configurations, a DRAM may be mounted on a third substrate. These substrates are connected by, for example, TSV, Cu—Cu connection, or microbumps.

According to the present embodiment, by sharing the readout wiring 130 by the capacitors 132, the weighted addition circuit 19 can suppress an increase in the number of wirings. Even if the number of signals to be added increases, the weighted addition circuit 19 sequentially sample-holds the signals and performs the weighted addition, so it is possible to eliminate the trade-off between the number of weighted additions and the number of wirings.

Further, according to the present embodiment, the weighted addition circuit 19 accepts an input of signals from the cell array via a common vertical signal line VSL. In the present embodiment, a ratio of the number of vertical signal lines VSL to the number of weighted addition circuits 19 is 1:1. This makes it possible to reduce the number of circuit vertical signal lines VSL.

Furthermore, according to the present embodiment, the AD conversion section 13 accepts inputs of the reset signal and the data signal separately from the weighted addition circuit 19, thereby enabling the CDS operation to be also realized in addition to the weighted addition.

Furthermore, according to the present embodiment, the weighted addition circuit 19 can connect to not only the pixel array section 20 but also the cell array such as the memory array to perform the weighted addition. Accordingly, the weighted addition circuit 19 can realize the weighted addition in a mechanism other than the pixels 100 for retaining signals.

Moreover, according to the present embodiment, by connecting the cell array having the pixel sharing circuit configuration to the input side of the weighted addition circuit 19, weighting in the weighted addition circuit 19 can be further realized in addition to the weighting in the cell array.

Accordingly, it is possible to compensate for the weighting in the weighted addition circuit 19 when the weighting in the cell array is insufficient.

### Second Embodiment

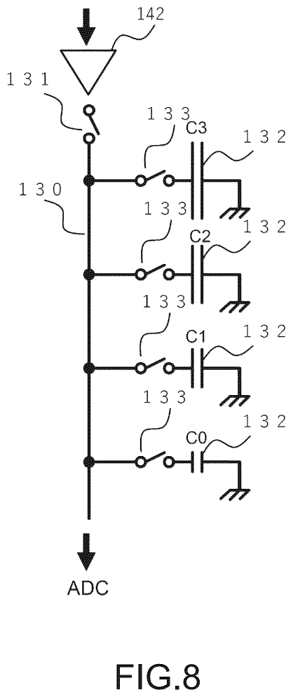

FIG. 8 is a circuit diagram of a weighted addition circuit according to a second embodiment.

In the weighted addition circuit 19, when the capacitances of the capacitors 132 for sample and hold differ, a time required for completing the accumulation of charges in the capacitors 132 may vary. For example, when the capacitor 132 has a small capacitance, the time required for completing the accumulation of charges is short, and when the capacitor 132 has a large capacitance, the time required for completing the accumulation of charges is long. In the present embodiment, the time required for completing the accumulation of charges is also called a settling time. In particular, in addition to the charge share used in the present embodiment, in the case of other capacitive load readouts (dynamic source follower, current addition, and/or the like), it is more favorable to suppress fluctuations of capacitance values.

The weighted addition circuit 19 according to the present embodiment includes a buffer circuit 142 between the vertical signal line VSL and the weighted addition circuit 19 so as to provide a delay time in the inputs of signals to be input to the weighted addition circuit 19 in accordance with the magnitudes of the capacitors 132. As the buffer circuit 142, for example, a source follower circuit or a unity gain buffer circuit may be used.

For example, when sample-holding in C0 having a small capacitance out of the capacitors 132, the buffer circuit 142 provides a delay time in the input of a signal to the weighted addition circuit 19. Further, when sample-holding in C3 having a large capacitance, the buffer circuit 142 does not provide a delay in the input to the weighted addition circuit 19.

In the present embodiment, similar to the first embodiment, not only the pixel array section 20 but also the cell array such as the memory array may be connected to the input side of the weighted addition circuit 19.

According to the present embodiment, the weighted addition circuit 19 can provide a delay time by the buffer circuit 142 when a signal is input to the weighted addition circuit 19, and suppress a deviation in the charge accumulation times due to a difference in the magnitude of the capacitance of the capacitors 132.

Furthermore, according to the present embodiment, the weighted addition circuit 19 can connect to not only the pixel array section 20 but also the cell array such as the memory array to perform the weighted addition. Accordingly, regarding the inputs from the mechanism for retaining signals, the weighted addition circuit 19 can suppress the deviation in the charge accumulation times due to the difference in the magnitude of the capacitance of the capacitors 132.

### Third Embodiment

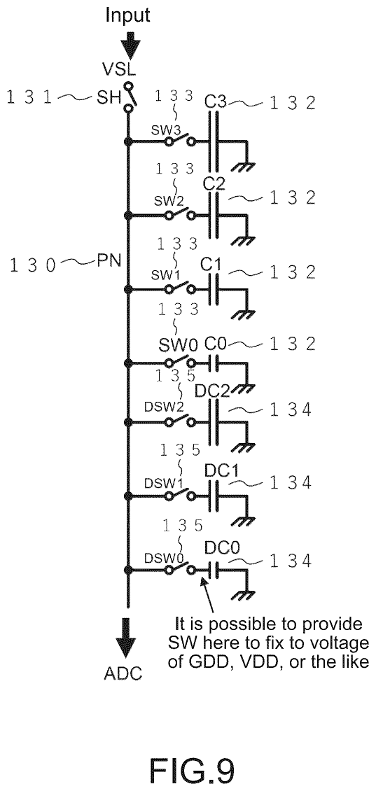

FIG. 9 is a circuit diagram of a weighted addition circuit according to a third embodiment.

The weighted addition circuit 19 according to the present embodiment includes dummy capacitors 134 and third switches 135 in addition to the capacitors 132 described above. The third switches 135 connect or disconnect the readout wiring 130 and the dummy capacitors 134.

The weighted addition circuit 19 accumulates charges in the dummy capacitors 134 based on the difference in the capacitance between the first capacitor and the second capacitor. When performing the sample and hold in the capacitors 132 having different capacitances, the weighted addition circuit 19 connects the dummy capacitors 134 to the readout wiring 130 and adjusts the difference in the capacitance so that a total value of the capacitances as viewed from the input side becomes constant. For example, while the weighted addition circuit 19 does not accumulate charges in the dummy capacitors 132 when performing the sample and hold in the first capacitor having a large capacitance, the weighted addition circuit 19 accumulates charges also in the dummy capacitors 134 when performing the sample and hold in the second capacitor having a small capacitance. Further, the charges accumulated in the dummy capacitors 134 are reset without performing the addition.

In the example shown in FIG. 9, the weighted addition circuit 19 includes three dummy capacitors 134 in addition to the four capacitors 132. In addition, each of the dummy capacitors 134 is connected to the readout wiring 130 via the third switch 135. Further, the capacitances of the four capacitors 132 are set to C3, C2, C1, and C0 from the input side. Furthermore, the capacitances of the three dummy capacitors 134 are set to DC2, DC1, and DC0 from the input side.

Further, descriptions will be given assuming that Equation (6) is established for each of the capacitors 132 and dummy capacitors 134.

$$\begin{matrix}C 3 = C 2 + DC 1 + DC 0 \\ = C 1 + DC 2 + DC 0 \\ = C 0 + DC 2 + DC 1\end{matrix} \qquad ( 7 )$$

Equation (7) is an example, and the capacitance value and number of the dummy capacitors 134 to be connected together with the capacitors 132 depend on the capacitance values of C3 to C0. This combination becomes a design parameter. In addition, in the weighted addition circuit 19, the number of capacitors 132 and the number of dummy capacitors 134 do not necessarily need to match, and the capacitance values of the dummy capacitors 134 may be the same value or may be different values.

Since the dummy capacitors 134 may constantly be floating capacitors, for example, an SW for fixing the voltage to a predetermined voltage, such as GND or VDD, may be provided between the third switch 135 and the dummy capacitor 134. Hereinafter, for simplification of explanation, descriptions will be given assuming that these configurations do not exist.

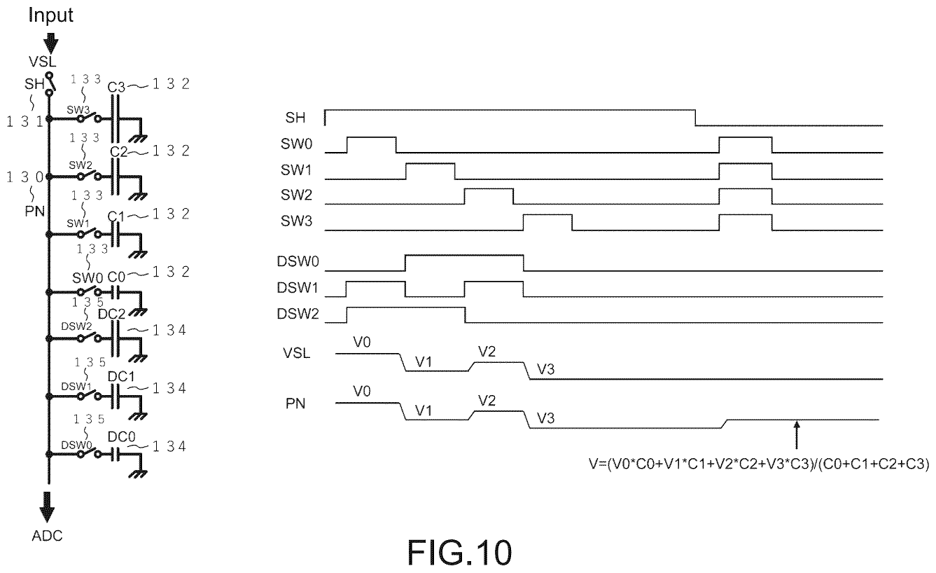

FIG. 10 is a timing chart of the weighted addition circuit according to the third embodiment.

The timing chart of FIG. 10 shows an example in which the capacitors 132 whose magnitudes of capacitances are C0, C1, C2, and C3 (C0<C1<C2<C3) sample-hold a plurality of signals (signal voltages V0 to V3) read out from the pixel array section 20 via the vertical signal line VSL. The timing chart of FIG. 10 also shows an example in which weighted addition is performed in the readout wiring 130 after completion of the sample and hold by the capacitors 132.

Also in the timing chart shown in FIG. 10, when performing the sample and hold in the capacitors 132, the weighted addition circuit 19 opens and closes the third switches 135 and also accumulates charges in the dummy capacitors 134 whose magnitudes of capacitances are DC0, DC1, and DC2 (DC0<DC1<DC2) so that the capacitors 132 become the same.

In this example, the second switches 133 connected to the capacitors 132 whose magnitudes of capacitances are C0, C1, C2, and C3 are represented by SW0, SW1, SW2, and SW3, respectively. Moreover, the third switches 135 connected to the dummy capacitors 134 whose magnitudes of capacitances are DC0, DC1, and DC2 are represented by DSW0, DSW1, and DSW2, respectively. A relational equation of the capacitances of the capacitors 132 and the dummy capacitors 134 is expressed by Equation (7).

Although the present embodiment shows the example in which the weighted addition circuit 19 turns on the second switches 133 in the order of SW0 to SW3 and performs sample and hold, the second switches 133 may be turned on in the order of SW3 to SW0, or may be turned on in other orders, for example.

First, the weighted addition circuit 19 turns on the first switch 131 to connect the vertical signal line VSL and the readout wiring 130, and accepts inputs of signals from the pixel array section 20. At this time, the voltage of SH becomes Hi, and such a voltage state is maintained until the weighted addition is completed.

Next, the weighted addition circuit 19 turns on SW0 out of the second switches 133, and connects the readout wiring 130 to C0 out of the capacitors 132. C0 accepts an input of a signal having a signal voltage V0 and sample-holds the signal. At this time, the voltage state of SW0 becomes Hi, and such a voltage state is maintained until a charge is accumulated in C0. In addition, the weighted addition circuit 19 turns on DSW1 and DSW2 out of the third switches 135, and connects the readout wiring 130 to DC1 and DC2 out of the dummy capacitors 134. In addition, a charge Q0 accumulated in C0 is expressed by Equation (1).

Next, the weighted addition circuit 19 turns on SW1 out of the second switches 133, and connects the readout wiring 130 to C1 out of the capacitors 132. C1 accepts an input of a signal having a signal voltage V1 and sample-holds the signal. At this time, the voltage state of SW1 becomes Hi, and such a voltage state is maintained until a charge is accumulated in C1. In addition, the weighted addition circuit 19 turns on DSW0 and DSW2 out of the third switches 135, and connects the readout wiring 130 to DC0 and DC2 out of the dummy capacitors 134. In addition, a charge Q1 accumulated in C1 is expressed by Equation (2).

Next, the weighted addition circuit 19 turns on SW2 out of the second switches 133, and connects the readout wiring 130 to C2 out of the capacitors 132. C2 accepts an input of a signal having a signal voltage V2 and sample-holds the signal. At this time, the voltage state of SW2 becomes Hi, and such a voltage state is maintained until a charge is accumulated in C2. In addition, the weighted addition circuit 19 turns on DSW0 and DSW1 out of the third switches 135, and connects the readout wiring 130 to DC0 and DC1 out of the dummy capacitors 134. In addition, a charge Q2 accumulated in C2 is expressed by Equation (3).

Next, the weighted addition circuit 19 turns on SW3 out of the second switches 133, and connects the readout wiring 130 to C3 out of the capacitors 132. C3 accepts an input of a signal having a signal voltage V3 and sample-holds the signal. At this time, the voltage state of SW3 becomes Hi, and such a voltage state is maintained until a charge is accumulated in C3. A charge Q3 accumulated in C3 is expressed by Equation (4). It is noted that the voltage of the readout wiring 130 when a charge is accumulated in C3 becomes V3.

After completing the sample and hold in the capacitors 132, the weighted addition circuit 19 turns on all of the second switches 133 and performs addition in the readout wiring 130. The signal voltage V of the readout wiring 130 at this time is expressed by Equation (5). It is noted that the charges accumulated in the dummy capacitors 134 are reset without being subjected to AD conversion.

As described above, the signal obtained by the weighted addition is input to the AD conversion section 13. Further, a bit-serial calculation can be performed by adding the signals while setting the capacitance ratio of C3 to C0 to be a power of 2.

Although this example has described the case where the weighted addition circuit 19 turns on the switches in the order of SW0, SW1, SW2, and SW3, this order is not limited, and the switches may be turned on in any order.

In the present embodiment, similar to the first embodiment, not only the pixel array section 20 but also the cell array such as the memory array may be connected to the input side of the weighted addition circuit 19.

According to the present embodiment, the weighted addition circuit 19 includes the dummy capacitors 134 in addition to the capacitors 132. Further, when performing the sample and hold in the capacitors 132, the weighted addition circuit 19 turns on the third switches 135 to also store charges in the dummy capacitors 134. Accordingly, the weighted addition circuit 19 can artificially adjust all of the capacitors 132 to become constant when performing the sample and hold, and suppress a deviation of the charge accumulation times due to a difference in the magnitude of the capacitance of the capacitors 132.

Furthermore, according to the present embodiment, the weighted addition circuit 19 can connect to not only the pixel array section 20 but also the cell array such as the memory array to perform weighted addition. Accordingly, regarding the input from the mechanism for retaining signals, the weighted addition circuit 19 can suppress the deviation of the charge accumulation times due to the difference in the magnitude of the capacitors 132.

### Fourth Embodiment

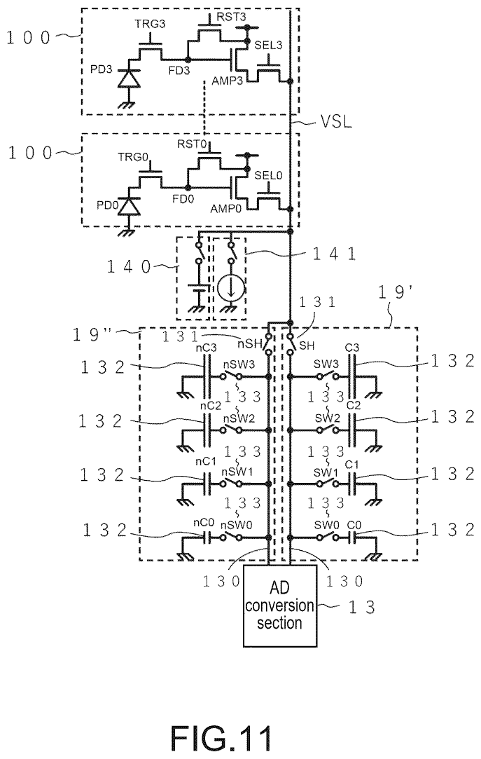

FIG. 11 is a circuit diagram of a weighted addition circuit and the like according to a fourth embodiment.

In the first to third embodiments, the descriptions have been given on the example in which the weighted addition circuit 19 performs weighted addition of positive values. For example, when performing a convolution calculation, the weighted addition circuit 19 may perform weighted addition of negative values.

In the present embodiment, the weighted addition circuit 19 includes a first weighted addition circuit 19′ that performs weighted addition of positive values and a second weighted addition circuit 19″ that performs weighted addition of negative values. In this configuration, the first weighted addition circuit 19′ and the second weighted addition circuit 19″ switch the first switches 131 thereof so that signals are input from the vertical signal line VSL, and the weighted additions are performed for positive values and negative values. In this example, the first switch 131 of the first weighted addition circuit 19′ is represented by SH, and the first switch 131 of the second weighted addition circuit 19″ is represented by nSH. Configurations of these weighted addition circuits 19′ and 19″ are similar to that shown in FIG. 3.

In other words, by turning on SH and turning off nSH, the first weighted addition circuit 19′ can perform the weighted addition of positive values, and by turning off SH and turning on nSH, the second weighted addition circuit 19″ can perform the weighted addition of negative values.

The weighted addition circuit 19 may execute the calculation of the positive values and negative values by individually inputting a result of the weighted addition of positive values and a result of the weighted addition of negative values to the AD conversion section 13, and obtaining a difference between these values using a subtraction circuit (not shown) and/or the like after performing AD conversion. Alternatively, the weighted addition circuit 19 may first obtain a difference between the results of the first weighted addition circuit 19′ and the second weighted addition circuit 19″ using the subtraction circuit and/or the like, and then the AD conversion section 13 may perform AD conversion on the differential signal.

Further, the weighted addition circuit 19 may reset the circuits that do not perform the sample and hold to an initial voltage before performing weighted addition. Furthermore, the weighted addition circuit 19 may turn on the second switches 133 associated with all of the capacitors 132 when performing weighted addition, or may turn on only the second switches 133 associated with the capacitors 132 that have executed the sample and hold. Since the weighting coefficient merely changes depending on the on state and off state of the second switches 133, the opened/closed state of the second switches 133 may be designed arbitrarily.

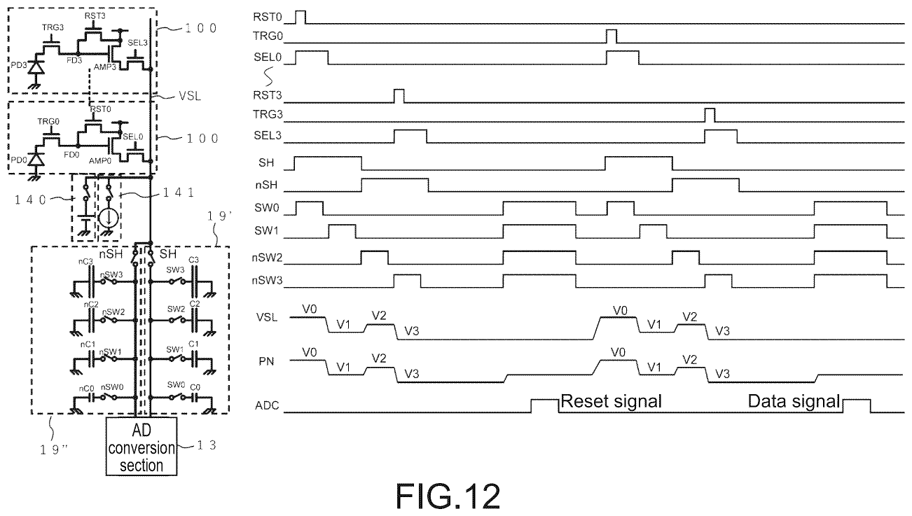

FIG. 12 is a timing chart of the weighted addition circuit and the like according to the fourth embodiment.

The circuit shown in FIG. 12 shows an example in which inputs of signals are sequentially accepted from four pixels 100 so as to perform sample and hold and weighted addition. Also in this example, two of the four pixels 100 input signals to the first weighted addition circuit 19′ to perform the weighted addition of positive values. Moreover, the remaining two pixels 100 input signals to the second weighted addition circuit 19″ to perform the weighted addition of negative values.

Similar to FIG. 5, this example shows a case where the AD conversion section 13 performs a CDS operation before performing the weighted addition. Also, this example shows a case where sample and hold is not performed on C2, C3, nC0, and nC1.

Specifically, using the timing chart of FIG. 12, first, in the pixel 100, as the readout of the P-phase level, the floating diffusion FD is initialized by the reset transistor RST0, the selection transistor SEL0 is turned on, and a reset level signal is transmitted to the weighted addition circuit 19. The weighted addition circuit 19 sample-holds the reset level signal by C0 which is the corresponding capacitor 132. After repeating this operation in C0, C1, nC2, and nC3, the weighted addition circuit 19 performs weighting, and after that, performs addition in the readout wiring 130. Further, the signal obtained by the addition is input to the AD conversion section 13 as a reset signal and is subjected to AD conversion.

Next, as the readout of the D-phase level, the pixel 100 turns on the transfer transistor TRG3 and further turns on the selection transistor SEL to transmit the charge accumulated in the photodiode PD to the weighted addition circuit 19. The weighted addition circuit 19 performs sample and hold by C0 which is the corresponding capacitor 132. The weighted addition circuit 19 repeats this operation in C0, C1, nC2, and nC3 to sample-hold the signals, and then performs weighted addition in the readout wiring 130. In this example, positive addition is performed for C0 and C1, and negative addition is performed for nC2 and nC3. A result of the weighted addition of positive values and a result of the weighted addition of negative values are input to the AD conversion section 13 as data signals and subjected to AD conversion. In this example, the calculation of positive values and the calculation of negative values are performed by obtaining a difference between these values by the subtraction circuit after the AD conversion. Also in the subtraction circuit, a difference between the difference signal of this data signal and the reset signal is obtained to remove fixed pattern noise.

In the present embodiment, the weighted addition circuit 19 may be connected to not only the pixel array section 20 but also the cell array such as the memory array to perform weighted addition.

According to the present embodiment, the weighted addition circuit 19 includes the second weighted addition circuit 19″ in addition to the first weighted addition circuit 19′. Accordingly, the weighted addition circuit 19 can perform the weighted addition of negative values in addition to the weighted addition of positive values.

Further, according to the present embodiment, by separately receiving the inputs of the reset signal and the data signal from the first weighted addition circuit 19′ and the second weighted addition circuit 19″, the AD conversion section 13 can also realize the CDS operation together with the weighted addition.

Furthermore, according to the present embodiment, the weighted addition circuit 19 can connect to not only the pixel array section 20 but also the cell array such as the memory array to perform the weighted addition. This makes it possible to realize the weighted addition in not only the pixel 100 but also the mechanism for retaining signals.

Furthermore, according to the present embodiment, the first weighted addition circuit 19′ and the second weighted addition circuit 19″ accept inputs of signals from the cell array via the common vertical signal line VSL. In the present embodiment, a ratio between the number of vertical signal lines VSL and the number of weighted addition circuits 19 is 1:2. Accordingly, it is possible to reduce the number of circuit vertical signal lines VSL.

### Fifth Embodiment

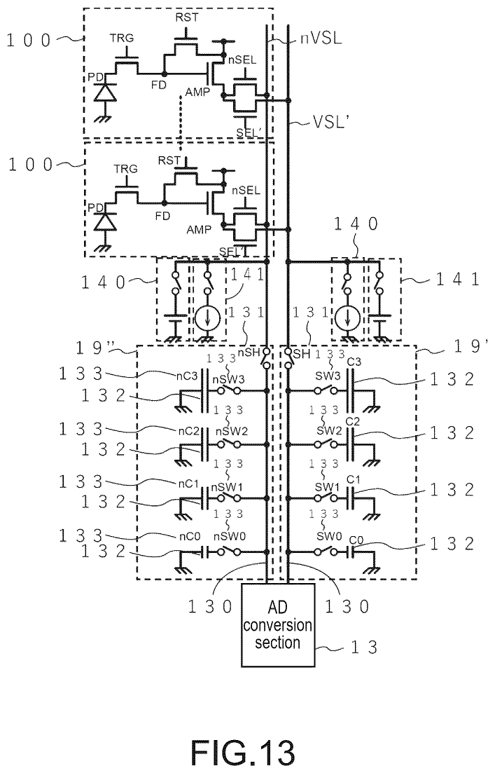

FIG. 13 is a circuit diagram of a weighted addition circuit and the like according to a fifth embodiment.

In the present embodiment, each of the pixels 100 includes a first selection transistor SEL′ that inputs a signal to the first weighted addition circuit 19′ via a first vertical signal line VSL′. Each of the pixels 100 also includes a second selection transistor nSEL that inputs a signal to the second weighted addition circuit 19″ via a second vertical signal line nVSL.

In the present embodiment, for the sake of explanation, a case where the pixel 100 includes the first selection transistor SEL′ and the second selection transistor nSEL will be taken as an example. However, the present disclosure is not limited to this example, and any configuration may be used as long as the cell described above such as the memory includes the first selection transistor SEL′ and the second selection transistor nSEL.

When performing the weighted addition of positive values, the pixel 100 turns on the first selection transistor SEL′ and turns off the second selection transistor nSEL, and inputs a signal to the first weighted addition circuit 19′. Moreover, when performing the weighted addition of negative values, the pixel 100 turns on the second selection transistor nSEL and turns off the first selection transistor SEL′, and inputs a signal to the second weighted addition circuit 19″. In this manner, the pixel 100 switches the first selection transistor SEL′ and the second selection transistor nSEL to input a signal to the first weighted addition circuit 19′ or the second weighted addition circuit 19″.

The first weighted addition circuit 19′ sequentially accepts inputs of signals from the pixels 100 whose first selection transistors SEL′ are on, and sample-holds the signals. Further, after the sample and hold is completed for all signals, the weighted addition of positive values is performed.

The second weighted addition circuit 19″ sequentially accepts inputs of signals from the pixels 100 whose second selection transistors nSEL are on, and sample-holds the signals. After the sample and hold is completed for all signals, the weighted addition of negative values is performed.

The weighted addition circuit 19 may execute the calculation of positive values and the calculation of negative values by individually inputting a result of the weighted addition of positive values and a result of the weighted addition of negative values to the AD conversion section 13, and obtaining a difference between these values using the subtraction circuit (not shown) and/or the like after the AD conversion. Alternatively, it is also possible to provide the subtraction circuit and/or the like in the weighted addition circuit 19, and after obtaining a difference between the first weighted addition circuit 19′ and the second weighted addition circuit 19″, the AD conversion section 13 may perform AD conversion on the difference signal.

According to the present embodiment, the cell includes the first selection transistor SEL′ and the second selection transistor nSEL. By switching these transistors, the cell can input a signal to the first weighted addition circuit 19′ or the second weighted addition circuit 19″. Accordingly, the weighted addition circuit 19 can perform the weighted addition of negative values in addition to the weighted addition of positive values.

Further, in the weighted addition circuit 19 according to the present embodiment, based on the opening and closing of the first selection transistor SEL′ and the second selection transistor nSEL, the first weighted addition circuit 19′ can input a signal of a positive value, and at the same time, the second weighted addition circuit 19″ can input a signal of a negative value.

Furthermore, according to the present embodiment, the first weighted addition circuit 19′ and the second weighted addition circuit 19″ accept the inputs of signals from the cell array via the first vertical signal line VSL′ and the second vertical signal line nVSL, respectively. In the present embodiment, the ratio between the number of vertical signal lines and the number of weighted addition circuits 19 is 1:1. Accordingly, it is possible to reduce the number of circuit vertical signal lines VSL.

### Sixth Embodiment

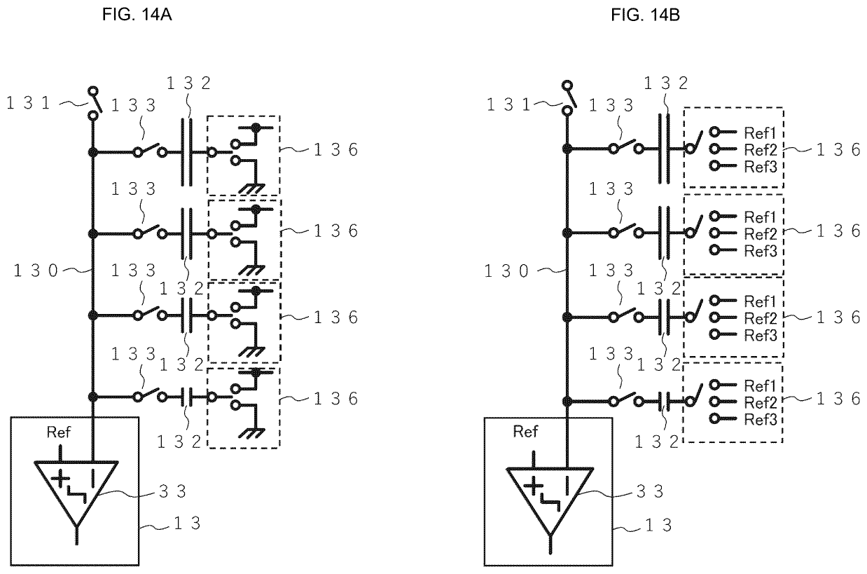

FIG. 14 are circuit diagrams of a weighted addition circuit and the like according to a sixth embodiment.

The weighted addition circuit according to the present embodiment includes fourth switches 136 that are each connected to a terminal of the capacitor 132 on an opposite side of a terminal on the readout wiring 130 side and enable a terminal voltage to be switched among a plurality of values.

FIG. 14A shows a configuration in which the fourth switch 136 is capable of setting the terminal voltage of the capacitor 132 on the opposite side of the readout wiring 130 to two values. For example, as the two values, values of GND and VDD may be set.

FIG. 14A also shows a comparator 33 included in the AD conversion section 13. A data signal is input to one of the inputs of the comparator 33, and a reference voltage Ref is input to the other one of the inputs.

FIG. 14B shows a configuration in which the fourth switch 136 is capable of setting the terminal voltage of the capacitor 132 on the opposite side of the readout wiring 130 to three values. In this example, the three values are represented as, Ref2, and Ref3.

The weighted addition circuit 19 sample-holds the signal in each of the capacitors 132, and fixes each of the fourth switches 136 to a predetermined value until weighted addition is performed after that. In FIG. 4A, for example, the voltage value of the fourth switch 136 may be fixed to a GND voltage. Further, after the weighted addition, the weighted addition circuit 19 inputs a data signal to the AD conversion section 13. Furthermore, during the AD conversion, the weighted addition circuit 19 successively switches the fourth switches 136 to generate a DAC signal, and inputs the DAC signal to the AD conversion section 13. The AD conversion section 13 can perform a successive comparison operation between the data signal and the DAC signal to realize successive comparison type (also called SAR (Successive Approximation Register) type) AD conversion.

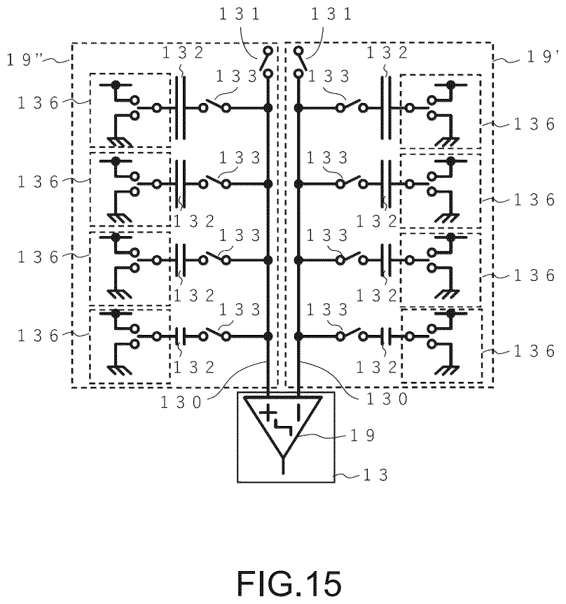

FIG. 15 is a circuit diagram of a modified example of the weighted addition circuit and the like according to the sixth embodiment.

The weighted addition circuit 19 shown in FIG. 15 includes the first weighted addition circuit 19′ that performs the weighted addition of positive values and the second weighted addition circuit 19″ that performs the weighted addition of negative values. Further, the first weighted addition circuit 19′ and the second weighted addition circuit 19″ each include the fourth switches 136 that each enable the terminal voltage of the capacitor 132 on the opposite side of the readout wiring 130 to be switched among a plurality of values. FIG. 15 shows a configuration in which the fourth switch 136 is capable of setting the terminal voltage of the capacitor 132 on the opposite side of the readout wiring 130 to two values.

The first weighted addition circuit 19′ and the second weighted addition circuit 19″ according to the present modified example sample-hold the signals in the capacitors 132, and fix the fourth switches 136 to a predetermined value until the weighted addition is performed after that. For example, the voltage value of the fourth switch 136 may be fixed to the GND voltage. Further, the first weighted addition circuit 19′ and the second weighted addition circuit 19″ input data signals to the AD conversion section 13. Furthermore, in performing AD conversion, the first weighted addition circuit 19′ and the second weighted addition circuit 19″ successively switch the fourth switches 136 to input DAC signals to the AD conversion section 13. Also in the result of the weighted addition of positive values and the result of the weighted addition of negative values, the AD conversion section 13 can successively compare the data signals and the DAC signals to realize the successive comparison type AD conversion.

According to the present embodiment, the weighted addition circuit 19 includes the fourth switches 136 that each enable the terminal voltage of the capacitor 132 on the opposite side of the readout wiring 130 to be switched among the plurality of values. Accordingly, the weighted addition circuit 19 can realize a function of a successive comparison type AD converter without separately adding the capacitor 132.

### <<Configuration Example of Vehicle Control System>>

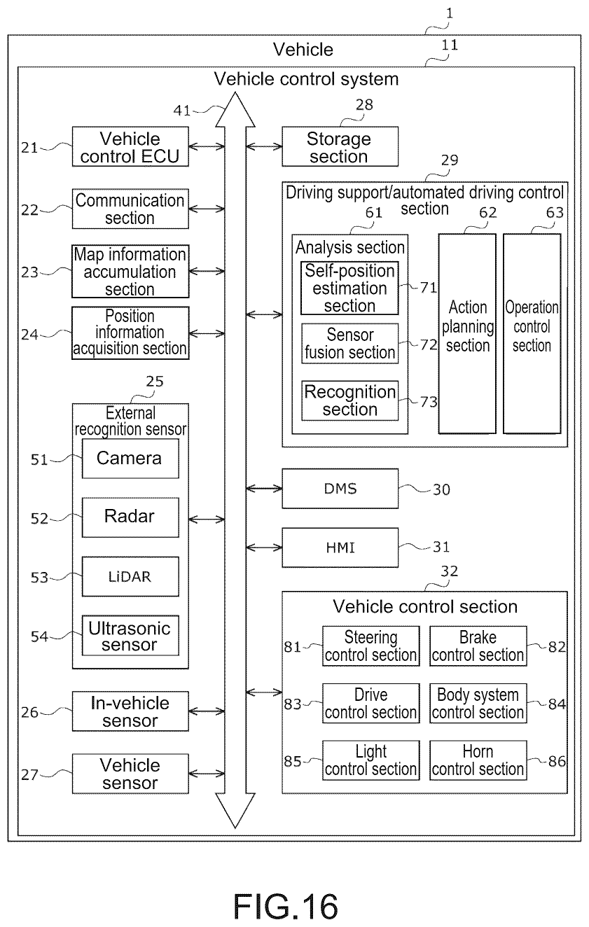

FIG. 16 is a block diagram showing a configuration example of a vehicle control system 11, which is an example of a mobile body control system to which the present technology is applied.

The vehicle control system 11 is provided in a vehicle 1 and performs processing related to driving support and automated driving of the vehicle 1.

The vehicle control system 11 includes a vehicle control ECU (Electronic Control section) 21, a communication section 22, a map information accumulation section 23, a position information acquisition section 24, an external recognition sensor 25, an in-vehicle sensor 26, a vehicle sensor 27, a storage section 28, a driving support/automated driving control section 29, a DMS (Driver Monitoring System) 30, an HMI (Human Machine Interface) 31, and a vehicle control section 32.

The vehicle control ECU 21, the communication section 22, the map information accumulation section 23, the position information acquisition section 24, the external recognition sensor 25, the in-vehicle sensor 26, the vehicle sensor 27, the storage section 28, the driving support/automated driving control section 29, the driver monitoring system (DMS) 30, the human machine interface (HMI) 31, and the vehicle control section 32 are communicably connected to each other via a communication network 41. The communication network 41 includes, for example, an in-vehicle communication network, a bus, and/or the like compliant with a digital bidirectional communication standard such as a CAN (Controller Area Network), a LIN (Local Interconnect Network), a LAN (Local Area Network), FlexRay®, or Ethernet®. The communication network 41 may be selectively used according to the type of data to be transmitted. For example, the CAN may be used for data related to vehicle control, and the Ethernet may be used for large-volume data. It is noted that the respective sections of the vehicle control system 11 may be connected not via the communication network 41 but directly via wireless communication that assumes communication at a relatively short distance, such as near-field communication (NFC) and Bluetooth®.

It is noted that hereinafter, when the respective sections of the vehicle control system 11 communicate with each other via the communication network 41, the communication network 41 will not be described. For example, when the vehicle control ECU 21 and the communication section 22 communicate with each other via the communication network 41, it is simply described that the vehicle control ECU 21 and the communication section 22 communicate with each other.

The vehicle control ECU 21 is implemented by, for example, various processors, such as a CPU (Central Processing Unit) and/or an MPU (Micro Processing Unit). The vehicle control ECU 21 controls all or a part of the functions of the vehicle control system 11.

The communication section 22 communicates with various devices inside the vehicle and outside the vehicle, other vehicles, servers, base stations, and/or the like, to transmit and receive various types of data. At this time, the communication section 22 can communicate using a plurality of communication technologies.

Communication that the communication section 22 is capable of executing with devices outside the vehicle will be schematically described. The communication section 22 communicates with a server or the like existing on an external network (hereinafter, will be referred to as an external server) via a base station or an access point by a wireless communication technology, the examples of which include 5G (5th Generation Mobile Communication System), LTE (Long Term Evolution), DSRC (Dedicated Short Range Communications), and the like. The external network with which the communication section 22 communicates is, for example, the Internet, a cloud network, a company-specific network, or the like. The communication technology used by the communication section 22 to communicate with the external network is not particularly limited as long as it is a wireless communication technology that enables digital bidirectional communication at a communication speed equal to or more than a predetermined speed and at a distance equal to or more than a predetermined distance.

Further, for example, the communication section 22 can communicate with terminals existing in the vicinity of the vehicle using a P2P (Peer To Peer) technology. The terminals existing in the vicinity of the vehicle include, for example, a terminal worn by a moving body moving at a relatively low speed, such as a pedestrian or a bicycle, a terminal installed at a fixed position in a store or the like, and/or an MTC (Machine Type Communication) terminal. In addition, the communication section 22 can also perform V2X communication. V2X communication refers to communication between a vehicle and another entity, the examples of which include vehicle-to-vehicle communication with another vehicle, vehicle-to-infrastructure communication with a roadside device or the like, vehicle-to-home communication with a home, vehicle-to-pedestrian communication with a terminal or the like carried by a pedestrian, and the like.

For example, the communication section 22 can receive a program for updating software for controlling the operation of the vehicle control system 11 from outside (Over The Air). In addition, the communication section 22 can receive map information, traffic information, information on surroundings of the vehicle 1, and/or the like from outside. Further, for example, the communication section 22 can transmit information related to the vehicle 1, information on the surroundings of the vehicle 1, and/or the like to the outside. Examples of the information related to the vehicle 1 that is transmitted to the outside by the communication section 22 include data indicating the state of the vehicle 1, a recognition result by a recognition section 73, and the like. Furthermore, the communication section 22 performs communication that supports a vehicle emergency call system, an example of which is eCall.

For example, the communication section 22 receives an electromagnetic wave transmitted by a road traffic information communication system (VICS (Vehicle Information and Communication System)®) using a radio wave beacon, an optical beacon, FM multiplex broadcasting, and/or the like.

The communication that the communication section 22 is capable of executing with the in-vehicle devices will be schematically described. The communication section 22 can communicate with the in-vehicle devices using wireless communication, for example. For example, the communication section 22 can wirelessly communicate with an in-vehicle device by any wireless communication technology that enables digital bidirectional communication at a communication speed equal to or more than a predetermined speed, examples of the wireless communication technologies including wireless LAN, Bluetooth, NFC, and WUSB (Wireless USB). The communication section 22 is not limited thereto, and the communication section 22 can also communicate with the in-vehicle devices using wired communication. For example, the communication section 22 can communicate with the in-vehicle devices by wired communication via a cable connected to a connection terminal (not shown). The communication section 22 can communicate with the in-vehicle devices by any wired communication technology that enables digital bidirectional communication at a communication speed equal to or more than a predetermined speed, examples of the wired communication technologies including USB (Universal Serial Bus), HDMI (High-Definition Multimedia Interface)®, and MHL (Mobile High-definition Link).

Here, the in-vehicle devices refer to, for example, devices that are not connected to the communication network 41 in the vehicle. Assumed as the in-vehicle devices are, for example, a mobile device or a wearable device carried by a user in the vehicle such as a driver, an information device brought in and temporarily installed in the vehicle, and the like.

The map information accumulation section 23 accumulates a map acquired from outside and/or a map created by the vehicle 1. For example, the map information accumulation section 23 accumulates a three-dimensional high-precision map, a global map having lower precision than the high-precision map and covering a wide area, and/or the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including a point cloud (point group data). The vector map is, for example, a map in which traffic information such as positions of lanes and/or traffic lights is associated with a point cloud map, for adaptation to ADAS (Advanced Driver Assistance System) and AD (Autonomous Driving).

The point cloud map and the vector map may be, for example, provided from an external server or the like, or may be created by the vehicle 1 as a map to be matched with a local map to be described later based on sensing results by a camera 51, a radar 52, a LiDAR 53, and the like, and may be accumulated in the map information accumulation section 23. Furthermore, in a case where a high-precision map is provided from an external server or the like, for example, map data of several hundred square meters regarding a planned path on which the vehicle 1 is to travel may be acquired from the external server or the like in order to reduce the amount of communication.

The position information acquisition section 24 receives GNSS (Global Navigation Satellite System) signals from a GNSS satellite to acquire position information of the vehicle 1. The acquired position information is supplied to the driving support/automated driving control section 29. It is noted that the position information acquisition section 24 is not limited to using GNSS signals, and the position information may be acquired using a beacon, for example.

The external recognition sensor 25 includes various sensors used for recognizing a situation outside the vehicle 1, and supplies sensor data from the sensors to the respective sections of the vehicle control system 11. The external recognition sensor 25 may include any type and any number of sensors.

For example, the external recognition sensor 25 includes the camera 51, the radar 52, the LiDAR (Light Detection and Ranging/Laser Imaging Detection and Ranging) 53, and an ultrasonic sensor 54. The external recognition sensor 25 is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

It is noted that the imaging method of the camera 51 is not particularly limited. For example, cameras that use various imaging methods with which distance measurement can be performed, such as a ToF (Time Of Flight) camera, a stereo camera, a monocular camera, and an infrared camera can be applied to the camera 51 as necessary. The camera 51 is not limited thereto and may be a camera for simply acquiring a captured image regardless of distance measurement.

Further, for example, the external recognition sensor 25 can include an environment sensor for detecting an environment with respect to the vehicle 1. The environment sensor is a sensor for detecting the environment such as a weather, a meteorological phenomenon, and brightness, and can include, for example, various sensors such as a rain drop sensor, a fog sensor, a sunshine sensor, a snow sensor, and an illuminance sensor.

In addition, for example, the external recognition sensor 25 includes a microphone used for detecting sound around the vehicle 1, a position of a sound source, and/or the like.

The in-vehicle sensor 26 includes various sensors for detecting information inside the vehicle, and supplies sensor data from the various sensors to the respective sections of the vehicle control system 11. The type and number of the various sensors included in the in-vehicle sensor 26 are not particularly limited as long as the types and numbers allow practical installation of the sensors in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, for example, cameras that use various imaging methods with which distance measurement can be performed, such as a ToF camera, a stereo camera, a monocular camera, and an infrared camera, can be used. The camera included in the in-vehicle sensor 26 is not limited thereto, and the camera may be a camera for simply acquiring a captured image regardless of distance measurement. The biological sensor included in the in-vehicle sensor 26 may be provided in, for example, a seat, a steering wheel, or the like, and may detect various types of biological information of a person in the vehicle, such as a driver.

The vehicle sensor 27 includes various sensors for detecting the state of the vehicle 1, and supplies sensor data from the various sensors to the respective sections of the vehicle control system 11. The type and number of the various sensors included in the vehicle sensor 27 are not particularly limited as long as the types and numbers allow practical installation of the sensors in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the rotation speed of an engine or a motor, an air pressure sensor that detects the air pressure of a tire, a slip rate sensor that detects the slip rate of a tire, and a wheel speed sensor that detects the rotation speed of a wheel. For example, the vehicle sensor 27 includes a battery sensor that detects a remaining amount and a temperature of a battery, and an impact sensor that detects an external impact.

The storage section 28 includes at least one of a nonvolatile storage medium or a volatile storage medium, and stores data and a program. The storage section 28 is used as, for example, an EEPROM (Electrically Erasable Programmable Read Only Memory) and a RAM (Random Access Memory), and a magnetic storage device such as an HDD (Hard Disc Drive), a semiconductor storage device, an optical storage device, and a magneto-optical storage device can be applied as the storage medium. The storage section 28 stores various programs and data used by the respective sections of the vehicle control system 11. For example, the storage section 28 includes an EDR (Event Data Recorder) and/or a DSSAD (Data Storage System for Automated Driving), and stores information of the vehicle 1 before and after an event such as an accident and/or information acquired by the in-vehicle sensor 26.

The driving support/automated driving control section 29 controls driving support and automated driving of the vehicle 1. For example, the driving support/automated driving control section 29 includes an analysis section 61, an action planning section 62, and an operation control section 63.

The analysis section 61 performs analysis processing of the situation of the vehicle 1 and/or a situation around the vehicle 1. The analysis section 61 includes a self-position estimation section 71, a sensor fusion section 72, and the recognition section 73.

The self-position estimation section 71 estimates the self-position of the vehicle 1 based on sensor data from the external recognition sensor 25 and a high-precision map accumulated in the map information accumulation section 23. For example, the self-position estimation section 71 estimates the self-position of the vehicle 1 by generating a local map based on sensor data from the external recognition sensor 25 and matching the local map with the high-precision map. As the position of the vehicle 1, for example, the center of the rear wheel pair axle is used as a reference.

For example, the local map is a three-dimensional high-precision map created using a technology such as SLAM (Simultaneous Localization and Mapping), an occupancy grid map, and/or the like. The three-dimensional high-precision map is, for example, the point cloud map described above or the like. The occupancy grid map is a map in which a three-dimensional or two-dimensional space around the vehicle 1 is divided into grids of a predetermined size, and an occupancy state of an object is indicated for each grid. The occupancy state of an object is indicated by, for example, the presence or absence or a presence probability of the object. The local map is also used for, for example, detection processing and recognition processing of a situation outside the vehicle 1 by the recognition section 73.

It is noted that the self-position estimation section 71 may estimate the self-position of the vehicle 1 based on the position information acquired by the position information acquisition section 24 and the sensor data from the vehicle sensor 27.

The sensor fusion section 72 performs sensor fusion processing of combining a plurality of different types of sensor data (for example, image data supplied from the camera 51 and sensor data supplied from the radar 52) to obtain new information. Methods for combining different types of sensor data include composite, integration, fusion, association, and the like.

The recognition section 73 performs detection processing of detecting a situation outside the vehicle 1 and recognition processing of recognizing a situation outside the vehicle 1.

For example, the recognition section 73 performs the detection processing and the recognition processing of a situation outside the vehicle 1 based on information from the external recognition sensor 25, information from the self-position estimation section 71, information from the sensor fusion section 72, and/or the like.

Specifically, for example, the recognition section 73 performs the detection processing, the recognition processing, and/or the like of an object around the vehicle 1. The detection processing of an object is, for example, processing of detecting the presence or absence, size, shape, position, movement, and/or the like of an object. The recognition processing of an object is, for example, processing of recognizing an attribute such as a type of an object and/or identifying a specific object. The detection processing and the recognition processing are not necessarily divided clearly, and may be duplicative.

For example, the recognition section 73 detects an object around the vehicle 1 by performing clustering to classify a point cloud that is based on sensor data from the radar 52, the LiDAR 53, or the like into clusters of point groups. Accordingly, the presence or absence, size, shape, and/or position of an object around the vehicle 1 are detected.

For example, the recognition section 73 detects the movement of an object around the vehicle 1 by tracking the movement of the clusters of point groups classified by clustering. Accordingly, the speed and the traveling direction (movement vector) of the object around the vehicle 1 are detected.

For example, the recognition section 73 detects or recognizes a vehicle, a person, a bicycle, an obstacle, a structure, a road, a traffic light, a traffic sign, a road sign, and/or the like based on the image data supplied from the camera 51. Further, the recognition section 73 recognizes the type of an object around the vehicle 1 by performing recognition processing such as semantic segmentation.

For example, the recognition section 73 can perform recognition processing of traffic rules around the vehicle 1 based on a map accumulated in the map information accumulation section 23, an estimation result of the self-position by the self-position estimation section 71, and a recognition result of an object around the vehicle 1 by the recognition section 73. Through this processing, the recognition section 73 can recognize the position and state of a traffic light, the contents of a traffic sign and a road sign, the contents of a traffic regulation, a travelable lane, and/or the like.

For example, the recognition section 73 can perform recognition processing of the environment around the vehicle 1. A weather, a temperature, a humidity, brightness, a state of the road surface, and the like are assumed as the surrounding environment to be recognized by the recognition section 73.

The action planning section 62 creates an action plan of the vehicle 1. For example, the action planning section 62 creates an action plan by performing processing of path planning and path following.

It is noted that the path planning (Global path planning) is processing of planning a rough path from the start to the goal. This path planning also includes processing of generating a trajectory in the vicinity of the vehicle 1 through which the vehicle 1 can safely and smoothly travel along the planned path given the motion characteristics of the vehicle 1 (Local path planning), which is also referred to as trajectory planning.

The path following is processing of planning an operation for safe and accurate traveling on a path planned by the path planning within a planned time. For example, the action planning section 62 can calculate a target speed and a target angular velocity of the vehicle 1 based on a result of this path following processing.

The operation control section 63 controls the operation of the vehicle 1 in order to achieve the action plan created by the action planning section 62.

For example, the operation control section 63 controls a steering control section 81, a brake control section 82, and a drive control section 83 included in the vehicle control section 32 to be described later, to perform acceleration and deceleration control and direction control such that the vehicle 1 travels on the trajectory calculated by the trajectory planning. For example, the operation control section 63 performs cooperative control for the purpose of realizing ADAS functions such as collision avoidance or impact mitigation, inter-vehicle distance control, vehicle speed control, vehicle collision warning, and lane departure warning. For example, the operation control section 63 performs cooperative control for the purpose of automated driving and/or the like for autonomously traveling without operation of a driver.

The DMS 30 performs authentication processing of the driver, recognition processing of the state of the driver, and/or the like based on sensor data from the in-vehicle sensor 26, input data input to the HMI 31 to be described later, and/or the like. Examples of the state of the driver to be recognized include a physical condition, an arousal level, a concentration level, a fatigue level, a line-of-sight direction, a drunkenness level, a driving operation, a posture, and the like.

It is noted that the DMS 30 may perform authentication processing of a person in the vehicle other than the driver and recognition processing of the state of that person. Further, the DMS 30 may perform recognition processing of a situation inside the vehicle based on sensor data from the in-vehicle sensor 26. Examples of the situation inside the vehicle to be recognized include a temperature, a humidity, brightness, odor, and the like.

The HMI 31 receives various types of data, instructions, and the like as an input and presents various types of data to the driver and/or the like.

The data input to the HMI 31 will be schematically described. The HMI 31 includes an input device used by a person to input data. The HMI 31 generates an input signal based on the data, instruction, and/or the like input by the input device, and supplies the input signal to the respective sections of the vehicle control system 11. The HMI 31 includes, for example, operators such as a touch panel, a button, a switch, and a lever as the input device. The HMI 31 is not limited thereto and may further include an input device that enables information to be input by a method other than a manual operation, such as voice, gesture, and/or the like. In addition, the HMI 31 may use, for example, a remote control device that uses infrared rays or radio waves and/or an external connection device such as a mobile device and a wearable device adaptive to the operation of the vehicle control system 11, as an input device.

Presentment of data by the HMI 31 will be schematically described. The HMI 31 generates visual information, auditory information, and tactile information for the person in the vehicle or for the outside of the vehicle. Furthermore, the HMI 31 performs output control for controlling an output, an output content, an output timing, an output method, and/or the like for each piece of generated information. As the visual information, the HMI 31 generates and outputs, for example, an operation screen, a state display of the vehicle 1, a warning display, an image such as a monitor image indicating a situation around the vehicle 1, and information indicated by light. Further, as the auditory information, the HMI 31 generates and outputs, for example, information indicated by sound, such as voice guidance, a warning sound, and a warning message. Furthermore, as the tactile information, the HMI 31 generates and outputs, for example, information given to the tactile sense of a person in the vehicle by force, vibration, movement, and/or the like.

As the output device to which the HMI 31 outputs the visual information, for example, a display device that presents the visual information by displaying an image by itself and/or a projector device that presents the visual information by projecting an image can be applied. It is noted that the display device may be, for example, a head-up display, a transmissive display, or a device that displays visual information in the field of view of a person in the vehicle, such as a wearable device having an AR (Augmented Reality) function, in addition to the display device including a normal display. Furthermore, the HMI 131 can also use a display device included in a navigation device, an instrument panel, a CMS (Camera Monitoring System), an electronic mirror, a lamp, and/or the like provided in the vehicle 1 as the output device to which the visual information is output.

As the output device to which the HMI 31 outputs the auditory information, for example, an audio speaker, a headphone, and/or an earphone can be applied.

As the output device to which the HMI 31 outputs the tactile information, for example, a haptic element that uses a haptic technology can be applied. The haptic element is provided at, for example, a portion where the person in the vehicle 1 touches, such as a steering wheel or a seat.

The vehicle control section 32 controls the respective sections of the vehicle 1. The vehicle control section 32 includes the steering control section 81, the brake control section 82, the drive control section 83, a body system control section 84, a light control section 85, and a horn control section 86.

The steering control section 81 performs detection, control, and/or the like of the state of the steering system of the vehicle 1. The steering system includes, for example, a steering mechanism including a steering wheel and the like, an electric power steering, and/or the like. The steering control section 81 includes, for example, a steering ECU that controls the steering system, an actuator that drives the steering system, and/or the like.

The brake control section 82 performs detection, control, and/or the like of the state of the brake system of the vehicle 1. The brake system includes, for example, a brake mechanism including a brake pedal and the like, an ABS (Antilock Brake System), a regenerative brake mechanism, and/or the like. The brake control section 82 includes, for example, a brake ECU that controls the brake system, an actuator that drives the brake system, and/or the like.

The drive control section 83 performs detection, control, and/or the like of the state of the drive system of the vehicle 1. The drive system includes, for example, an accelerator pedal, a driving force generation device for generating a driving force for an internal combustion engine, a driving motor, or the like, a driving force transmission mechanism for transmitting the driving force to the wheels, and/or the like. The drive control section 83 includes, for example, a drive ECU that controls the drive system, an actuator that drives the drive system, and/or the like.

The body system control section 84 performs detection, control, and/or the like of the state of the body system of the vehicle 1. The body system includes, for example, a keyless entry system, a smart key system, a power window device, a power seat, an air conditioner, an airbag, a seat belt, a shift lever, and/or the like. The body system control section 84 includes, for example, a body system ECU that controls the body system, an actuator that drives the body system, and/or the like.

The light control section 85 performs detection, control, and/or the like of the states of various lights of the vehicle 1. Examples of the light to be controlled include a headlight, a backlight, a fog light, a turn signal, a brake light, a projector light, a display of a bumper, and the like. The light control section 85 includes a light ECU that controls a light, an actuator that drives the light, and/or the like.

The horn control section 86 performs detection, control, and/or the like of the state of the car horn of the vehicle 1. The horn control section 86 includes, for example, a horn ECU that controls the car horn, an actuator that drives the car horn, and/or the like.

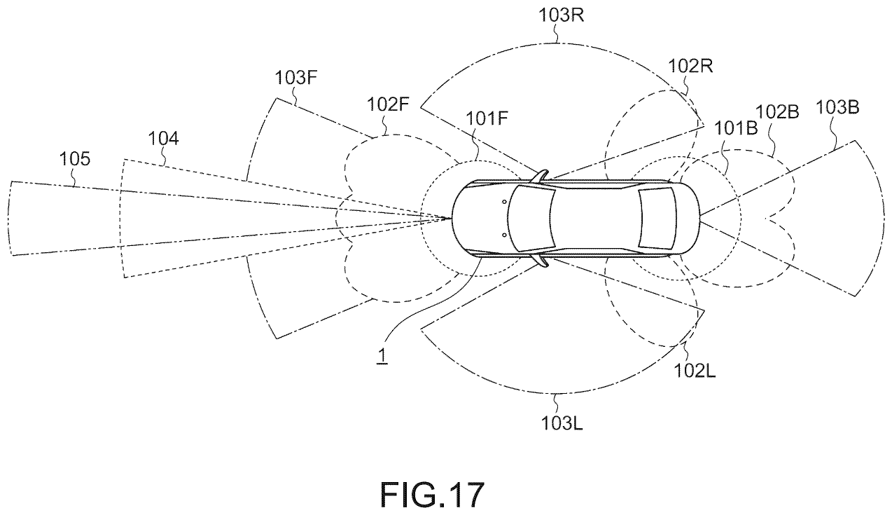

FIG. 17 is a diagram showing an example of sensing areas of the camera 51, the radar 52, the LiDAR 53, the ultrasonic sensor 54, and the like of the external recognition sensor 25 in FIG. 16. It is noted that FIG. 17 schematically shows the vehicle 1 as viewed from above, with the left end side being the front end (front) side of the vehicle 1 and the right end side being the rear end (rear) side of the vehicle 1.

A sensing area 101F and a sensing area 101B are examples of the sensing areas of the ultrasonic sensor 54. The sensing area 101F covers the periphery of the front end of the vehicle 1 by the plurality of the ultrasonic sensors 54. The sensing area 101B covers the periphery of the rear end of the vehicle 1 by the plurality of the ultrasonic sensors 54.

The sensing results in the sensing area 101F and the sensing area 101B are used in, for example, parking assistance of the vehicle 1, and the like.

A sensing area 102F to a sensing area 102B indicate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. The sensing area 102L covers the rear periphery of the left side of the vehicle 1. The sensing area 102R covers the rear periphery of the right side of the vehicle 1.

The sensing result in the sensing area 102F is used in, for example, detection or the like of a vehicle, a pedestrian, or the like that is present on the front side of the vehicle 1. The sensing result in the sensing area 102B is used in, for example, a collision prevention function or the like on the rear side of the vehicle 1. The sensing results in the sensing area 102L and the sensing area 102R are used in, for example, detection or the like of an object in blind spots on sides of the vehicle 1.

A sensing area 103F to a sensing area 103B indicate examples of sensing areas of the camera 51. The sensing area 103F covers a position farther than the sensing area 102F in front of the vehicle 1. The sensing area 103B covers a position farther than the sensing area 102B behind the vehicle 1. The sensing area 103L covers the periphery of the left side of the vehicle 1. The sensing area 103R covers the periphery of the right side of the vehicle 1.

The sensing result in the sensing area 103F can be used in, for example, recognition of a traffic light and/or a traffic sign, a lane departure prevention assist system, and/or an automatic headlight control system. The sensing result in the sensing area 103B can be used in, for example, parking assistance and/or a surround view system. The sensing results in the sensing area 103L and the sensing area 103R can be used in, for example, a surround view system.

A sensing area 104 indicates an example of a sensing area of the LiDAR 53. The sensing area 104 covers a position farther than the sensing area 103F in front of the vehicle 1. On the other hand, the sensing area 104 has a narrower range in the left-right direction than the sensing area 103F.

The sensing result in the sensing area 104 is used in, for example, detecting an object such as a peripheral vehicle.

A sensing area 105 indicates an example of the sensing area of the radar 52 for a long distance. The sensing area 105 covers a position farther than the sensing area 104 in front of the vehicle 1. On the other hand, the sensing area 105 has a narrower range in the left-right direction than the sensing area 104.

The sensing result in the sensing area 105 is used in, for example, ACC (Adaptive Cruise Control), emergency braking, collision avoidance, and/or the like.

It is noted that the sensing areas of the sensors including the camera 51, the radar 52, the LiDAR 53, and the ultrasonic sensor 54 included in the external recognition sensor 25 may take various configurations other than those shown in FIG. 17. Specifically, the ultrasonic sensors 54 may also sense the sides of the vehicle 1, and the LiDAR 53 may sense the rear of the vehicle 1. Further, the installation positions of the sensors are not limited to the examples described above. In addition, the number of sensors may be one or more.

Heretofore, the present disclosure has been described by way of the embodiments and modified examples thereof, the application examples, and the applications, but the present disclosure is not limited to the embodiments and the like described above and can be variously modified. It is noted that the effects described in the present specification are mere examples. The effects of the present disclosure are not limited to the effects described in the present specification. The present disclosure may have effects other than those described in the present specification.

It is noted that the present technology can also take the following configurations, for example.

(1)

A weighted addition circuit, including:
a readout wiring which accepts an input of a plurality of signals read out by a vertical signal line of a solid-state image pickup apparatus;
a first switch which connects or disconnects the vertical signal line and the readout wiring;
a plurality of capacitors which sample-hold the plurality of signals; and
a plurality of second switches which connect or disconnect the readout wiring and the capacitors.
   (2)

The weighted addition circuit according to (1), in which
the solid-state image pickup apparatus includes
a cell array including a mechanism for retaining the plurality of signals,
the vertical signal line which reads out the plurality of signals from the cell array, and
an AD conversion section which performs AD conversion of a signal obtained by performing weighted addition in the weighted addition circuit, in which
the weighted addition circuit is connected to the cell array, the vertical signal line, and the AD conversion section.
   (3)

The weighted addition circuit according to (1), in which
the weighted addition circuit
sequentially sample-holds the plurality of signals sequentially read out by the vertical signal line, and
performs weighted addition after completing the sample and hold of the plurality of signals.
   (4)

The weighted addition circuit according to (2), in which
a plurality of cells included in the cell array are pixels including photodiodes or memories included in a memory array.
   (5)

The weighted addition circuit according to (2), further including:
a fourth switch which enables a terminal of each of the plurality of capacitors, that is on an opposite side of a terminal on a side of the readout wiring, to switch a value of a terminal voltage.
   (6)

The weighted addition circuit according to (5), in which
the AD conversion section performs a successive comparison operation of a DAC signal generated by the weighted addition circuit on the basis of the switch by the fourth switch and the signal obtained by the weighted addition.
   (7)

A solid-state image pickup apparatus, including:
a cell array including a mechanism for retaining a plurality of signals;
a vertical signal line which reads out the plurality of signals from the cell array;
a weighted addition circuit which sample-holds the plurality of signals read out by the vertical signal line and performs weighted addition; and
an AD conversion section which performs AD conversion of a signal obtained by performing the weighted addition in the weighted addition circuit, in which
the weighted addition circuit includes
a readout wiring which accepts an input of the plurality of signals read out by the vertical signal line,
a first switch which connects or disconnects the vertical signal line and the readout wiring,
a plurality of capacitors which sample-hold the plurality of signals, and
a plurality of second switches which connect or disconnect the readout wiring and the capacitors.
   (8)

The solid-state image pickup apparatus according to (7), in which
the weighted addition circuit
sequentially sample-holds the plurality of signals sequentially read out by the vertical signal line, and
performs the weighted addition after completing the sample and hold of the plurality of signals.
   (9)

The solid-state image pickup apparatus according to (7), in which
a plurality of cells included in the cell array are pixels including photodiodes or memories included in a memory array.
   (10)

The solid-state image pickup apparatus according to (7), in which
the plurality of capacitors include a first capacitor and a second capacitor having different capacitances.
   (11)

The solid-state image pickup apparatus according to (7), in which
a buffer circuit which provides a delay time in the input of the plurality of signals is connected between the vertical signal line and the weighted addition circuit.
   (12)

The solid-state image pickup apparatus according to (10), in which
the weighted addition circuit further includes
one or a plurality of dummy capacitors which adjust a difference between the capacitances during the sample and hold by the first capacitor and the second capacitor, and
one or a plurality of third switches which connect or disconnect the readout wiring and the dummy capacitors.
   (13)

The solid-state image pickup apparatus according to (12), in which
the weighted addition circuit accumulates a charge in the one or plurality of dummy capacitors on the basis of the difference between the capacitance of the first capacitor and the capacitance of the second capacitor.
   (14)

A solid-state image pickup apparatus, including:
a cell array including a mechanism for retaining a plurality of signals;
a vertical signal line which reads out the plurality of signals from the cell array;
a first weighted addition circuit which sample-holds the plurality of signals read out by the vertical signal line and performs weighted addition of positive values;
a second weighted addition circuit which sample-holds the plurality of signals read out by the vertical signal line and performs weighted addition of negative values; and
an AD conversion section which performs AD conversion of a signal obtained by the weighted addition in the first weighted addition circuit and a signal obtained by the weighted addition in the second weighted addition circuit, in which
each of the first weighted addition circuit and the second weighted addition circuit includes
a readout wiring which accepts an input of the plurality of signals read out by the vertical signal line,
a first switch which connects or disconnects the vertical signal line and the readout wiring,
a plurality of capacitors which sample-hold the plurality of signals, and
a plurality of second switches which connect or disconnect the readout wiring and the capacitors.
   (15)

The solid-state image pickup apparatus according to (14), in which
a plurality of cells included in the cell array are pixels including photodiodes or memories included in a memory array.
   (16)

The solid-state image pickup apparatus according to (14), in which
each of the first weighted addition circuit and the second weighted addition circuit
sequentially sample-holds the plurality of signals sequentially read out by the vertical signal line, and
performs the weighted addition of the positive values and the weighted addition of the negative values after completing the sample and hold of the plurality of signals.
   (17)

The solid-state image pickup apparatus according to (14), in which
a plurality of cells included in the cell array include
a first selection transistor which makes a switch so that the plurality of signals are input to the first weighted addition circuit, and
a second selection transistor which makes a switch so that the plurality of signals are input to the second weighted addition circuit.
   (18)

The solid-state image pickup apparatus according to (8), in which
the weighted addition circuit further includes a fourth switch which enables a terminal of each of the plurality of capacitors, that is on an opposite side of a terminal on a side of the readout wiring, to switch a value of a terminal voltage.
   (19)

The solid-state image pickup apparatus according to (18), in which
the AD conversion section performs a successive comparison of a DAC signal generated by the weighted addition circuit on the basis of the switch by the fourth switch and the signal obtained by the weighted addition.
   (20)

The solid-state image pickup apparatus according to (14), in which
each of the first weighted addition circuit and the second weighted addition circuit further includes a fourth switch which enables a terminal of each of the plurality of capacitors, that is on an opposite side of a terminal on a side of the readout wiring, to switch a value of a terminal voltage.

### REFERENCE SIGNS LIST

1 vehicle
10 solid-state image pickup apparatus
11 vehicle control system
12 vertical drive section
13 AD conversion section
14 horizontal drive section
15 control section
16 signal processing circuit
17 data storage section
18 input/output section
19 weighted addition circuit
19′ weighted addition circuit
19″ weighted addition circuit
20 pixel array section
21 vehicle control ECU
22 communication section
23 map information accumulation section
24 position information acquisition section
25 external recognition sensor
26 in-vehicle sensor
27 vehicle sensor
28 storage section
29 driving support/automated driving control section
30 DMS
31 HMI
32 vehicle control section
33 comparator
41 communication network
42 photoelectric conversion film
43 transparent electrode
44 lower electrode
51 camera
52 radar
53 LiDAR
54 ultrasonic sensor
61 analysis section
62 action planning section
63 operation control section
71 self-position estimation section
72 sensor fusion section
73 recognition section
81 steering control section
82 brake control section
83 drive control section
84 body system control section
85 light control section
86 horn control section
100 pixel
130 readout wiring
131 first switch
132 capacitor
133 second switch
134 dummy capacitor
135 third switch
136 fourth switch
140 voltage source
141 current source
142 buffer circuit

1. A weighted addition circuit, comprising:
a readout wiring which accepts an input of a plurality of signals read out by a vertical signal line of a solid-state image pickup apparatus;
a first switch which connects or disconnects the vertical signal line and the readout wiring;
a plurality of capacitors which sample-hold the plurality of signals; and
a plurality of second switches which connect or disconnect the readout wiring and the capacitors.

2. The weighted addition circuit according to claim 1, wherein
the solid-state image pickup apparatus includes
a cell array including a mechanism for retaining the plurality of signals,
the vertical signal line which reads out the plurality of signals from the cell array, and
an AD conversion section which performs AD conversion of a signal obtained by performing weighted addition in the weighted addition circuit, wherein
the weighted addition circuit is connected to the cell array, the vertical signal line, and the AD conversion section.

3. The weighted addition circuit according to claim 1, wherein
the weighted addition circuit
sequentially sample-holds the plurality of signals sequentially read out by the vertical signal line, and
performs weighted addition after completing the sample and hold of the plurality of signals.

4. The weighted addition circuit according to claim 2, wherein
a plurality of cells included in the cell array are pixels including photodiodes or memories included in a memory array.

5. The weighted addition circuit according to claim 2, further comprising:
a fourth switch which enables a terminal of each of the plurality of capacitors, that is on an opposite side of a terminal on a side of the readout wiring, to switch a value of a terminal voltage.

6. The weighted addition circuit according to claim 5, wherein
the AD conversion section performs a successive comparison operation of a DAC signal generated by the weighted addition circuit on a basis of the switch by the fourth switch and the signal obtained by the weighted addition.

7. A solid-state image pickup apparatus, comprising:
a cell array including a mechanism for retaining a plurality of signals;
a vertical signal line which reads out the plurality of signals from the cell array;
a weighted addition circuit which sample-holds the plurality of signals read out by the vertical signal line and performs weighted addition; and
an AD conversion section which performs AD conversion of a signal obtained by performing the weighted addition in the weighted addition circuit, wherein
the weighted addition circuit includes
a readout wiring which accepts an input of the plurality of signals read out by the vertical signal line,
a first switch which connects or disconnects the vertical signal line and the readout wiring,
a plurality of capacitors which sample-hold the plurality of signals, and
a plurality of second switches which connect or disconnect the readout wiring and the capacitors.

8. The solid-state image pickup apparatus according to claim 7, wherein
the weighted addition circuit
sequentially sample-holds the plurality of signals sequentially read out by the vertical signal line, and
performs the weighted addition after completing the sample and hold of the plurality of signals.

9. The solid-state image pickup apparatus according to claim 7, wherein
a plurality of cells included in the cell array are pixels including photodiodes or memories included in a memory array.

10. The solid-state image pickup apparatus according to claim 7, wherein
the plurality of capacitors include a first capacitor and a second capacitor having different capacitances.

11. The solid-state image pickup apparatus according to claim 7, wherein
a buffer circuit which provides a delay time in the input of the plurality of signals is connected between the vertical signal line and the weighted addition circuit.

12. The solid-state image pickup apparatus according to claim 10, wherein
the weighted addition circuit further includes
one or a plurality of dummy capacitors which adjust a difference between the capacitances during the sample and hold by the first capacitor and the second capacitor, and
one or a plurality of third switches which connect or disconnect the readout wiring and the dummy capacitors.

13. The solid-state image pickup apparatus according to claim 12, wherein
the weighted addition circuit accumulates a charge in the one or plurality of dummy capacitors on a basis of the difference between the capacitance of the first capacitor and the capacitance of the second capacitor.

14. A solid-state image pickup apparatus, comprising:
a cell array including a mechanism for retaining a plurality of signals;
a vertical signal line which reads out the plurality of signals from the cell array;
a first weighted addition circuit which sample-holds the plurality of signals read out by the vertical signal line and performs weighted addition of positive values;
a second weighted addition circuit which sample-holds the plurality of signals read out by the vertical signal line and performs weighted addition of negative values; and
an AD conversion section which performs AD conversion of a signal obtained by the weighted addition in the first weighted addition circuit and a signal obtained by the weighted addition in the second weighted addition circuit, wherein
each of the first weighted addition circuit and the second weighted addition circuit includes
a readout wiring which accepts an input of the plurality of signals read out by the vertical signal line,
a first switch which connects or disconnects the vertical signal line and the readout wiring,
a plurality of capacitors which sample-hold the plurality of signals, and
a plurality of second switches which connect or disconnect the readout wiring and the capacitors.

15. The solid-state image pickup apparatus according to claim 14, wherein
a plurality of cells included in the cell array are pixels including photodiodes or memories included in a memory array.

16. The solid-state image pickup apparatus according to claim 14, wherein
each of the first weighted addition circuit and the second weighted addition circuit
sequentially sample-holds the plurality of signals sequentially read out by the vertical signal line, and
performs the weighted addition of the positive values and the weighted addition of the negative values after completing the sample and hold of the plurality of signals.

17. The solid-state image pickup apparatus according to claim 14, wherein
a plurality of cells included in the cell array include
a first selection transistor which makes a switch so that the plurality of signals are input to the first weighted addition circuit, and
a second selection transistor which makes a switch so that the plurality of signals are input to the second weighted addition circuit.

18. The solid-state image pickup apparatus according to claim 8, wherein
the weighted addition circuit further includes a fourth switch which enables a terminal of each of the plurality of capacitors, that is on an opposite side of a terminal on a side of the readout wiring, to switch a value of a terminal voltage.

19. The solid-state image pickup apparatus according to claim 18, wherein
the AD conversion section performs a successive comparison of a DAC signal generated by the weighted addition circuit on a basis of the switch by the fourth switch and the signal obtained by the weighted addition.

20. The solid-state image pickup apparatus according to claim 14, wherein
each of the first weighted addition circuit and the second weighted addition circuit further includes a fourth switch which enables a terminal of each of the plurality of capacitors, that is on an opposite side of a terminal on a side of the readout wiring, to switch a value of a terminal voltage.
